(19) United States
(12) Patent Application Publication
(10) Pub. No.: US 2015/0242944 A1
(43) Pub. Date: Aug. 27, 2015

(54) TIME DEPENDENT INVENTORY ASSET MANAGEMENT SYSTEM FOR INDUSTRIES HAVING PERISHABLE ASSETS

(71) Applicants: Eugene S. Willard, Gaithersburg, MD (US); Polina Sokolovsky, Los Angeles, CA (US)

(72) Inventors: Eugene S. Willard, Gaithersburg, MD (US); Polina Sokolovsky, Los Angeles, CA (US)

(21) Appl. No.: 14/710,510

(22) Filed: May 12, 2015

Related U.S. Application Data
(63) Continuation-in-part of application No. 14/033,219, filed on Sep. 20, 2013, now abandoned.
(60) Provisional application No. 61/992,143, filed on May 12, 2014.

(51) Int. Cl. G06Q 30/06; G06Q 30/02; G06Q 10/02

(52) U.S. Cl. CPC G06Q 30/0645; G06Q 10/02; G06Q 30/0284

(57) ABSTRACT

The invention provides an automated TDIAM system which includes algorithms using a geographic information system which can calculate drive time automatically at time of reservation by taking into account the geometry of the road network, expected construction delays, weather patterns, and historical traffic conditions and speed to determine the “least cost” route on the date and time of service and from the pickup location to the drop off location. If the GIS is experiencing an outage and is not available, or in countries where GIS Systems do not yet have the geometry of the road system established but at least have major points of interest geocoded, an alternative approach to computing drive time must be used. This approach involves use of geocodes to establish the origin and destination points and the proprietary application of three dimensional geometry and related formulas to calculate the estimated drive time.

The present Patent Application claims the priority benefit of 35 U.S.C. section 119 of U.S. Provisional Patent Application No. 61/992,143 filed May 12, 2014, entitled “Time Dependent Inventory Asset Management (Tdiam) System For The Chauffeured Transportation Industry”; which application is a continuation-in-part of U.S. non-provisional application Ser. No. 14/033,219 filed Sep. 20, 2013, and now abandoned entitled “Time Dependent Inventory Asset Management (Tdiam) System For Industries Having Perishable Assets” which application is related and also claims the priority benefit under 35 U.S.C. section 119 of U.S. Provisional Patent Application No. 61/703,763 filed on 20 Sep. 2012, entitled “Distribution of inventory in Ground Transportation Industry Utilizing Time Segments As An Inventory Subject and Maintaining Inventory Database Utilizing Time Segments, Either Fixed Or Floating”, whose entire contents are all incorporated herein by reference.

### 1.1 TDIAM BUSINESS PROBLEM DOMAIN

TDIAM defines a business problem domain that includes one or more variable time dimensions related to managing a basic unit of a perishable asset. It is useful to give examples of well understood inventory management problems that lack this variable time dimension to clarify the TDIAM problem domain. An airline seat, a hotel room, and a rental car, for example, are all perishable inventories that are purchased for a fixed period of time. In the case of an airline seat, the fixed period of time is the duration of the flight. In the case of a hotel room or rental car, the fixed period of time is a predefined room night or a rental day. The absence of a variable period of time related to managing these inventory assets simplifies the business problem domain related to inventory management.

Other industries like chauffeured transportation, however, present additional inventory management complexity by having one or more variable periods of time associated with managing the basic unit of inventory. For chauffeured transportation, the basic unit of perishable inventory constitutes the vehicle and the chauffeur who operates that vehicle for a period of time. (Greeter staff also constitute a perishable inventory and require separate discussion.) Contrary to airline seats, hotel rooms, and rental cars, however, the passenger can rent the chauffeur and vehicle for variable periods of time. For example, passengers who request a pickup or drop off at an airport or Point-to-Point service could experience two very different drive times depending on whether their trip takes place during peak versus off peak traffic periods. Use of the same route to go from a downtown city location to the airport can have two very different drive times in the morning and evening rush hours versus after rush hour. In addition, passengers can request Hourly Service for a minimum number of hours and extend their service well beyond the minimum number of hours based on decisions made at time of reservation. This is typically also true for greeter staff.

Additional complexities occur when material drive time is associated with staging the chauffeur and vehicle from a theoretical center point of the serviced geography to the pickup point, or returning that chauffeur and vehicle from the drop off point to the center point. This inventory staging time is frequently factored into the actual price of the service delivery based on the availability and location of the assigned chauffeur and vehicle on the date of service just prior to the pickup time and just after the drop off time. This “staging time” accounts for the situations where the chauffeur and vehicle are likely to have an “empty leg” either after the next previous trip and/or after the trip being priced. Other time dependencies can occur if the passenger chooses to make stops on airport pickups and drop offs or Point-to-Point service or if the passenger keeps the chauffeur and vehicle waiting beyond the planned pickup or drop off time.

The common inventory management metric in all of these time dimensions is drive time. Drive time and the total rental period are what logically should determine the cost of the trip since during this time period the unit of inventory is being constrained from resale to other customers. Pricing the service in this manner should be “rational” to the customer and create behaviors that will free up inventory for resale to other customers when appropriate. The use of this common factor to determine if the availability of a unit of inventory is open or closed as well as to price the service offers opportunities to simplify the TDIAM business problem domain with algorithms that are drive time and service time dependent.

In addition to algorithms to achieve coarse grained inventory controls and basic rational pricing practices, the use of drive time and driving distance calculations also can become the basis for calculating the carbon footprint and offset of fulfilling a trip with a specific vehicle type. Corporations and individual retail consumers with carbon neutral programs and aspirations will have this additional information at time of reservation to help them make their transportation decisions. These calculations also can become the basis for the development of fine grained rational pricing and revenue management controls. For a variety of reasons, the chauffeured transportation industry has not traditionally embraced the rational pricing and revenue management disciplines—the fragmentation in the industry, the intellectual capital required to develop the business processes and technology assets, and the capital investments required to fund that development. The ability to manage complex pricing, inventory management, and related logistics problems with computer assisted solutions will result in both improved customer service and increased supplier profitability.

Looking further into the future, a TDIAM System can facilitate solutions to many pressing socio-economic and related mobility problems facing large metropolitan areas within and outside of the domestic United States:
An estimated population increase of 1B by 2025, with the vast majority of this growth concentrated in already heavily congested metropolitan areas in emerging markets,
33K traffic fatalities annually in the domestic U.S. and 1.24 M fatalities worldwide, with 90% of these fatalities attributable to human error,
5.3 M traffic accidents per year contribute to 50 M injuries per year worldwide with $200 B per year in medical, property, and productivity losses—the so called “crash economy”,
By 2013, an estimated 73 M people age 65+ still in need of mobility,
An estimated 56.7 M people are disabled and 46% of them work—many travel 2+ hours per day to work,
30% of greenhouse gas emissions are attributable to vehicle exhaust with 2.98 B gallons of fuel lost annually from vehicles sitting in traffic,
5.5 M hours of lost time annually—in a networked society, time on the road needs to be productive,
Insufficient parking space particularly in high density urban areas.

Clearly, these problems have to get solved and any surface transportation distribution system must anticipate the approaching shift, already in progress, from private ownership of vehicles to shared mobility solutions (i.e., the passenger does not own the vehicle) and from chauffeured transportation fleets to fleets of fully autonomous vehicles (i.e., no driver intervention is required to operate the vehicle). Google has promised a fully autonomous vehicle as early as 2017 and Nissan, Mercedes, and several other car and truck manufacturers are in a race to create a fully autonomous vehicle by 2020. The STI Global System anticipates these shifts with a distribution, reservations, and inventory management system that will transition seamlessly to the new, fully autonomous vehicles and shared mobility solutions.

Federal, state, and city transportation planning organizations anticipate that Self-Drive, Autonomous Vehicles and Shared Mobility Solutions (i.e., shared ride, vehicle share, shuttle service, bike share, carpooling, etc.) will serve as key answers to these challenges. A TDIAM supports a seamless transition to these solutions.

In addition, a TDIAM System can adopt standard search arguments to retrieve availability for all relevant forms of private and public sector surface transportation, thereby creating a simple, consistent, intuitive Integrated Proactive Intermodal Travel Assistant (IPITA) that empowers the consumer with the information needed to make informed surface transportation decisions. An IPITA for surface transportation can enable booking of multi-modal, surface transportation itineraries and help assure that future transportation solutions are consumer driven and span an optimal mix of public and private sector solutions.

The introduction of coarse grained controls (i.e., open or closed to availability) to manage a perishable inventory also affords an opportunity to introduce fine grained controls used by most other travel verticals—airline, hotel, rental car, and cruise line companies—to maximize supplier revenue and profitability. These benefits will be realized by creating “rational pricing” and revenue management concepts and developing inventory and pricing controls tailored to the TDIAM and the chauffeured transportation industry. These concepts and controls will be explained in detail in Section 5.0 of this document.

### 1.2 TDIAM KEY INNOVATIONS

Use of a geographic information system (e.g., Google Maps, Bing Maps, Oracle Spatial, or ESRI), enables automatic calculation of drive time at time of reservation. By taking into account the geometry of the road network and historical traffic conditions and speed, the network analysis function of a GIS can determine the “least cost” (where cost is actually drive time) route on the date and time of service and from the pickup location to the drop off location. The network analysis function typically considers multiple routes to accomplish transportation from the pickup to the drop off location and then selects the least cost route.

If the GIS is experiencing an outage and is not available, or in countries where GIS Systems do not yet have the geometry of the road system established but at least have major points of interest geocoded, an alternative approach to computing drive time must be used. This approach would involve use of geocodes to establish the origin and destination points and the application of four dimensional geometry and related formulas to calculate the estimated drive time.

By using a calendar to keep track of the estimated pickup and drop off times for reservations throughout a 24 hour period for each unit of inventory, an inventory management system can thereby maintain the availability of each vehicle. The inventory management system also effectively eliminates the need to dispatch the trip manually on the date of service. In effect, the passenger dispatches the trip by selecting the date, pickup time, and pickup and drop off locations at time of reservation. Suppliers need only then manage exception situations (i.e., vehicle breakdowns or accidents during service delivery).

The ability to calculate driving distance via use of a GIS also affords an opportunity to calculate the carbon footprint of the trip and the cost of the corresponding carbon offset. (The Vehicle Identification Number or the year, make, and model of the car also is needed to calculate the carbon footprint.) These facts can then be presented as part of the response to an availability message so that corporate or retail customers who have carbon neutral initiatives can factor these metrics into their transportation decisions.

By applying cost and margin factors to the total estimated drive time (e.g., $ X.XX per minute of drive time), a pricing system also can calculate the estimated cost of the trip. In addition, incidental costs like tolls, airport fees, parking fees, local taxes, and carbon offset costs could be added to the GIS by identifying these costs as part of a road segment or by associating these costs with a set of geocodes. Based on the “least cost” route selected by the GIS, the pricing system can then factor these incidental costs and the carbon footprint and offset into the total cost of the trip, providing an “all-inclusive” price quote at time of shopping and the opportunity to settle the credit card transaction when the reservation is confirmed versus after the service delivery, thereby improving supplier cash flow and profitability.

This route also can be persisted, and if the fleet of vehicles servicing a given geography have GPS transmitters, an automated job closeout and reconciliation process can compare the least cost route proposed at time of reservation to the actual route taken by the vehicle. This reconciliation can determine whether or not incidental costs, local taxes, and estimated carbon footprint and offset costs were actually incurred and trigger a final credit card transaction to add or subtract these costs. A final zero balance trip invoice can then be sent to the customer via email or fax providing this reconciliation both for the passenger and travel arranger.

Use of a GIS also can simplify set up of point-to-point transfer rates—traditionally a labor intensive and error prone task involving definition of zones based on zip code pairs. Instead of zip code pairs, suppliers could use a GIS system to draw the zones and then export the set of geocodes that define that zone using standard export utilities. These zone definitions, which are effectively geo-fences, can then be loaded into the pricing system and standard GIS functions used by the pricing system can determine if the pickup and drop off locations are within any of the pre-defined zones.

Finally, the search and booking parameters used for chauffeured transportation are readily extensible to many forms of public and private sector surface transportation, enabling the TDIAM to server as an IPITA.

To recap the innovations introduced by a full-function TDIAM System:
Automated, coarse grained, inventory management of an individual vehicle or fleet of vehicles using a calendar that can track variable rental periods and maintain accurate availability at the individual vehicle level of detail.
The ability for a service provider to define a network of local market “farm out” partners who can contribute inventory to the TDIAM System. The ability of a service provider to “farm out” trips automatically when the service provider's own inventory is no longer available. The ability to have such farm out trips priced automatically and billed to the customer's credit card, and to split this payment between the service provider and the farm out partner based on pre-defined pricing schedules.
The ability for a service provider to define a network of remote affiliate partners in other markets who can contribute inventory to the TDIAM System. The ability of a service provider to delegate trips automatically when the service provider lacks owned inventory in those markets. The ability to have such delegated trips priced automatically and billed to the customer's credit card, and the ability to split this payment between the service provider and the affiliate partner based on pre-defined pricing schedules.
Automated, alternative workforce and vehicle management options by service provider with distinct goals, and with the ability to assign either option to a given day or series of days for a given type and/or number of individual vehicles:
   Option 1—An even distribution of jobs across all available vehicles and drivers that meet the trip requirements until there is no more availability across all vehicles. This option seeks an equitable distribution of trips across all available vehicles and drivers.
   Option 2—Availability and reservations processing automatically seek the vehicles having the most number of confirmed trips first (starting with the vehicle that has the most assigned trips) until these vehicles no longer have the availability to meet the given requirements for a trip. This option seeks optimal utilization of each vehicle and driver, resulting in less vehicles, less congestion, less accidents, and less greenhouse gas emissions.
Automated dispatch of the vehicle by the passenger at time of reservation, thereby eliminating the need for manual dispatch just prior to the service delivery.
Simplified setup of zone pricing using a GIS to draw the zones, export of geocodes defining each zone, loading of these zone definitions into the pricing system, and use of standard GIS functions at time of reservation to determine if a set of pickup and drop off locations fall within a defined zone.
Support for searching, shopping, and booking intermodal journeys consisting of mixed use of private and public sector transportation solutions.
Refinement of single and intermodal itinerary searches using constraints such as least cost, number and type of modes of transportation, total trip duration, vehicle age, supplier safety rating, supplier customer service rating, and carbon footprint and offset cost,
In exception situations (e.g. mechanical failure, accidents, or severe traffic congestion), automated reassignment and dispatch of a trip to the nearest available affiliate or farm out partner vehicle whose inventory is managed by the STI Global System.
Use of geo-fencing to trigger alerts to the service provider's dispatch office that a driver will be late to the pickup point.
The ability for a service provider to monitor remotely on a GPS console an affiliate delegated trip during the actual service delivery. In exception situations, the ability for the service provider to use internet based chat with the affiliate dispatch office and driver to help recover service problems.
In such exception situations, when a farm out or affiliate partner does not have available inventory, automated reassignment of the trip to a new service provider based on search for the nearest available vehicle meeting the trip requirements or on a pre-defined prioritization scheme.
In situations where a service provider has no availability, the automated ability to search for an available vehicle owned by a pre-defined affiliate or “farm out” partner in the same or different geography and dispatch the trip to the partner vehicle. Prevention of affiliate and farm out partners from delegating such trips to their respective affiliate and farm out partners since the inventory is always physical inventory and the TDIAM System can enforce only one degree of delegation for physical inventory under its control.
Proprietary application of four dimensional geometry to calculate drive time in geographies where the road network has not yet been mapped and historical and real-time traffic information may not yet be available.
Use of a GIS System to calculate the “least cost” route using the GIS network analysis function, where least cost can range from the total cost of the trip, the total duration of the trip, the number of modes of transportation, the carbon footprint and offset cost, and similar costs associated with a surface transportation itinerary,
Application of cost and margin factors to the total drive time to enable accurate pricing,
Association of incidental costs like tolls, airport fees, parking fees, local taxes, and carbon offset costs as part of the road geometry, or with a set of geocodes, to enable an all-inclusive price quote at time of reservation,
Given an all-inclusive price quote, the ability to perform credit card settlements at time of reservation,
Persistence in the reservations data base of the least cost route used at time of reservation and the actual route taken during service delivery,
Automated comparison and reconciliation of the costs quoted at time of reservation with the costs of the actual route taken and issuance to the consumer of a zero balance statement,
Based on the pricing reconciliation, automated processing of a credit card settlement to achieve final job closeout and creation and transmittal of a zero balance statement for the passenger and the arranger using email, fax, or text message,
Use of a GIS to simplify zone pricing using geo-fences, and the ability for the pricing engine to determine if a pickup and drop off location fall within a geo-fence corresponding to a pricing zone,
Use of fine grained inventory management and pricing controls, predictive analytics technologies (i.e., operations research models, artificial intelligence and knowledge representation, and machine learning), and the concepts of Personalization, Rational Pricing, and Revenue Management to enable, for the first time, chauffeured transportation suppliers to optimize their revenue and profitability.
Use of advanced statistical methods—e.g., Bayesian Probabilities—to generate in real-time during availability and reservations processing or in batch processing mode relevant and personalized offers to consumers of surface transportation.
Use of predictive analytics technologies to automate and optimize the staging of inventory throughout a given day near the location of shifting patterns of demand based on historical and real-time statistics and the availability status of an already scheduled individual vehicle and a larger fleet of available vehicles.
Use of GPS Tracking, geo-fencing, and exception based alerts to automate the tracking of farm out and affiliate delegated trips.
Use of a Vehicle Guidance System to assign an initial route from a Central Distribution and Inventory Management System to an autonomous vehicle for purposes of fulfilling a for hire private or public sector surface transportation itinerary. Also, the ability of such a system to interact with Central Transportation Management Systems, Road Sensor Systems, and Vehicle-to-Vehicle (V2V) Systems when one or more of these systems changes the originally assigned route as a result of traffic congestion, construction, or accidents. Finally, reporting of such route modifications back to the Central Distribution and Inventory Management System so that they can be persisted to support final pricing reconciliation and a zero balance statement for the consumer.
Use of semantic search technology and consistent, intuitive search and booking parameters for all forms of private and public sector surface transportation to support planning and booking of single and multimodal itineraries and the creation of a surface transportation IPITA.

All of these innovations would be welcomed by both the consumers and suppliers of chauffeured transportation. These new processes represent major breakthroughs in process reengineering, creating increased operational efficiency, pricing integrity, customer service, and customer satisfaction. This overall approach also can significantly simplify the design and development of three of the most complex applications in any order entry and fulfillment system supporting chauffeured transportation—inventory management, pricing, and dispatch.

### 1.3 TDIAM APPLICATION VALUE PROPOSITION

The absence of mature solutions to TDIAM related problems and the current fragmentation in the industry has delayed integration of the chauffeured transportation suppliers with global channels like the Global Distribution Systems (GDSs), Online Travel Agencies (OTAs), and the Central Reservation Systems (CRSs) of other travel verticals (e.g., the airlines and hotels) who desire to sell ancillary services such as chauffeured transportation to increase their revenue and profitability. In the chauffeured transportation industry, inventory management, pricing, dispatch, and job closeout and reconciliation have all tended to be highly manual in nature and therefore error prone. In particular, without an automated solution to inventory management, exposing existing chauffeured transportation systems to global distribution channels poses serious customer service risks related to overbooking available inventory, particularly during peak processing times. Operators also face increased exposure to pricing errors that can lead to loss of profitability and further customer dissatisfaction. Another frequent source of error happens at time of dispatch, a highly manual process that involves matching the right chauffeur and vehicle to the right customer shortly before the service delivery. Job closeout and pricing reconciliation also have traditionally been highly manual processes and prone not only to error but also to fraud.

Legacy chauffeured transportation systems also lack the rich content, business context awareness, and personalization features required by global channels to make the shopping experience relevant to their consumers and travel arrangers, who are demanding access to more and more information to drive their travel buy decisions. Finally the software architectures that have traditionally been used to host legacy chauffeured transportation systems lack the scalability, performance, and availability required to service global distribution channels. The vast majority of these systems use a two-tier, legacy software architecture that simply cannot stand up to the availability and response time requirements and the business volumes posed by connectivity with multiple global channels during peak processing periods.

A centralized system that solves these problems in a cost effective manner will transform the industry and open up significant opportunities for suppliers and global channel partners to increase their revenue and profitability. All availability and reservations transactions will process through this centralized system to maintain integrity in tracking inventory availability and to unburden local supplier systems of the “heavy lifting” required to integrate with global channels. The centralized system will push confirmed reservations electronically to the local chauffeured transportation systems, which will manage and support service fulfillment, customer service, and back office accounting.

The local systems will, in turn, sync any mid-office changes affecting inventory (e.g., extra stops, adds, changes, and cancels processed by the dispatch office) back to the central system. This approach will reduce the development cost, risk, and time to revenue of the central front office applications, offer software investment protection to suppliers who have already invested in a local system, and still preserve an important role for the chauffeured transportation software providers in supporting their customers' service fulfillment activities.

### 1.4 CONCEPTUAL DESIGN FOR THE CHAUFFEURED TRANSPORTATION TDIAM APPLICATION

The functional design of the TDIAM Application for the chauffeured transportation industry must reduce the complexity and risk of integrating with global channels by relying on fully automated methods for managing inventory availability, for calculating prices, and for dispatching the vehicle. This approach also will accelerate roll out of the centralized system to chauffeured transportation suppliers.

The following sections present key components of this application and how they interact with other front office applications.

### 1.4.1 Geographic Information System (GIS) Component and Proprietary Algorithms

Upon receipt of an Availability Request, a Reservation Add Request, or a Reservation Change Request, the Pricing Engine Component of the base Inventory Management Application will use an off-the-shelf, GIS packaged software application supplemented by proprietary algorithms to perform all of the required drive time calculations and cost calculations needed to check for availability and quote pricing. The latitude and longitude coordinates of both the pickup and drop off locations are key inputs expected as part of the inbound message payload of an Availability Request, a Reservation Add Request, and a Reservation Change Request coming from a contact center or electronic channel. Note that these inputs will be part of the contract articulated by the Application Programming Interfaces (API's) governing the exchange of information for these transactions.

In the rare instance when the latitude and longitude (hereafter referred to as “lat/long”) coordinates are not present, the base Inventory Management Application will submit the pickup and drop off locations to the GIS and receive back the lat/long coordinates for both locations, the estimated drive time, and the estimated mileage for the trip. If either the pickup or drop off locations cannot be geocoded, the Reservation Application will return a denial response message clearly identifying the missing data.

If the lat/long coordinates are present, the base Inventory Management Application will submit these coordinates for the pickup and drop off locations to the Network Analysis function of the GIS, which uses the actual road geometry between the pickup and drop off points and historical traffic information to determine the “least cost” route. The GIS will then return the estimated drive time and mileage for the trip. In cases where the GIS has not yet mapped the road geometry between the requested pickup and drop off locations, or when the GIS is incurring an outage and is not available, but the points of interest in a geography are geocoded, proprietary algorithms using three dimensional geometry will be used to calculate an estimate of the drive time, driving distance, and trip price.

A component closely related to the GIS is the GPS Tracking and Console Component. This component is used to display near real-time vehicle location for the Dispatch Office and also to collect GPS coordinates for the actual service delivery. These coordinates can then be compared to those of the least cost route computed at time of reservation. This comparison becomes the basis for an automated job closeout and reconciliation process.

The response message will include as separate components of the drive time any staging time required from the geographic center point to the pickup location and from the drop off location back to the geographic center point. Alternatively, if the elapsed drive time from a previous drop off point to the next pickup point is less than the staging time from the drop off point to the center point, then this time will be used as part of the overall drive time calculation. The center point actually will consist of a pre-defined, geo-fenced area where the vehicle will be best positioned to acquire and respond to the next reservation.

### 1.4.2 Rate Management Table Component

A Rate Management Table will maintain key run time parameters defined by supplier that will govern how availability is determined and price quotes are calculated. These parameters will be more fully defined during the actual design phase of the system. Each supplier will define these parameters and they will contribute to each supplier's pricing calculation. These parameters will include, but not be limited to, the following:
In locations where the road geometry is not yet present in the GIS, for each defined Service Geography, up to six Drive Time Periods per day defining varying levels of demand and traffic speed that can affect overall trip durations.
In locations where the road geometry is not yet present in the GIS, Drive Time Increase Factors for each Drive Time Period (e.g., multiply the drive time calculated by the proprietary algorithms by a factor of X.X depending on the factor assigned to each Service Geography's Drive Time Period.
Driver Gratuity Percentage, or the standard gratuity percentage applied to the base cost of the trip included in the price quote.
In locations where the road geometry is not yet present in the GIS, Average Drive Time per Degree of Angle, expressed in whole minutes and used by the proprietary algorithms to compute the base drive time between the pickup and drop off locations (see Section 1.3.5.1 for additional explanation).
Valid Vehicle Types, with Maximum Passenger Count and Maximum Bag Count per vehicle type,
Base Unit Cost Applicable To Drive Time (e.g., each 5 minutes of drive time=$ XX.XX), equivalent to the marginal cost of operating the vehicle plus the minimum profit margin. Separate parameters may be maintained by vehicle type, for a standard rental vehicle versus a passenger of a shared ride transfer trip, and for other service types (e.g., hourly service, premium service, and executive car service).
Shared Ride Passenger Rate, or the flat rate per passenger added to the base rate for a shared ride trip.
Return Leg Percentage Probability, or return leg percentage demand. This percentage represents the probability that a trip will result in a return leg that effectively restages the chauffeur and vehicle at the theoretical center point of the operator's service area.
The Cost of an Empty Return Leg, which addresses the cost of restaging the driver and vehicle at the theoretical center point of the service area if the probability of a return leg is 0.00 percent.
Minimum Lead Time for Hourly and Point-to-Point Transfers, or the number of minutes prior to the pickup time the chauffeur should be on location.
Minimum Lead Time for Transportation Center Pickups and Drop Offs. Transportation centers are classified as airports, private aviation FBO's, heliports, train stations, ferry docks, or cruise docks. For drop offs, this parameter represents the lead time the chauffeur and vehicle must pick up the passenger in advance of the transportation service departure time. For pickups, this parameter represents the time in advance of the transportation service arrival time when the chauffeur and vehicle must be staged at the transportation center.
Maximum Permissible Number of Passengers and Bags for each vehicle type (e.g., a maximum of X passengers and Y bags are permissible for a standard sedan),
Lat and Long Coordinates for Geographic Center Point of an individual supplier's Service Geography,
Number of Minutes Prior to Pickup Time for vehicle to be on location (e.g., the vehicle must be on location X minutes prior to the pickup time),
Minimum Number of Hours Required for a reservation requesting Hourly Service (e.g., minimum of X hours rental for a reservation requesting Hourly Service),
On Demand Service Flag, valued Y or N, indicates whether or not the supplier provides immediate service with no lead time,
Minimum Lead Time Prior to Pickup Time to Accept a New Reservation (e.g., 2 hours lead time required to change pickup time or location),
Minimum Lead Time Prior to Pickup Time to Accept an Inventory Related Change (e.g., 2 hours lead time required to change pickup time, vehicle type, or pickup location),
Minimum Lead Time Prior to Pickup Time to Accept a Cancellation (e.g., 24 hours lead time required to cancel or change pickup time, vehicle type, or location),
Percent Discount Off of Base Rate used for rate quote (e.g., a corporate account receives a ten percent discount off of base rate),
Flat Rate applied to lat and long coordinate pairs (e.g., a corporate account is charged a flat rate for airport transfers originating from or dropping off at a specific corporate campus location),
Ancillary Services available by supplier and service area geography,
Ancillary Service Cost,
Minimum/Maximum Stop Time, a set number of minutes used to price stops,
Stop Cost, a fixed cost per stop,
Geography Exception Flag, which indicates pickup and drop off location pairs (or lat/long coordinate pairs) that require a GIS to calculate the drive time. The exceptions arise as a result of two locations separated by geographic features (e.g., a river, lake, or mountain) causing excessive error in calculating drive time using a straight line projection (or as the crow flies) for driving distance.
   A graphical user interface will allow suppliers to enter and maintain these run time parameters in the Rate Management Table.

### 1.4.3 Service Geography Additional Charges Table Component

Pricing of each trip at time of reservation will be “all inclusive” but the price quote will break out incidental charges like airport fees, parking fees, tolls, and ancillary services costs separately from the base rate of the trip to prevent customer service problems. To include these charges in the price quote versus just basic disclaimer text, the additional charges must be pre-defined and present in a table organized by geography and available to the pricing engine during processing of an availability or reservation request message. This table in conjunction with the pricing algorithms must include the intelligence to determine if an airport fee, parking fee, and/or toll charge applies to a given trip.

For airport fees and parking fees, this intelligence may simply amount to associating the fees with the lat/long coordinates of the pickup and drop off locations. Toll charges, however, can occur en route to the pickup and drop off locations and will therefore have to be detected by the pricing algorithms in a different manner. Mature GIS Systems like Oracle Spatial enable individual road segments to be associated with a “price,” which can be drive time and/or another set of costs; this feature could offer a relatively easy way to solve the all-inclusive pricing problem. This extension of the pricing algorithm will be further addressed during the design phase of the project.

### 1.4.4 Local Tax Table Component

Local taxes can apply across multiple jurisdictions if the actual service geography includes more than one tax jurisdiction. A separate table will store tax information by service geography and jurisdiction. Since many of the tax rules pertain to the route taken on the trip, the use of a GIS may also help to automate the calculation of the tax cost at time of reservation. Consideration also will be given to purchase of a packaged software application (e.g., ADP Taxware) that simplifies the application and calculation of taxes.

### 1.4.5 Carbon Footprint and Offset Cost Component

Using driving distance and information derived either from the Vehicle Identification Number (VIN) or the make, model, and year of the vehicle, the Pricing Engine Component will call a local service to calculate the carbon footprint and the offset cost. (There are several internet based services that provide these calculations—the TDIAM projected peak transaction volumes may warrant having this service run locally.) These calculations will be included on various response messages to allow consumers to understand the environmental impact of their transportation decisions and the cost of offsetting that impact. The payment methods will support customer inclusion or exclusion of the carbon offset cost as part of the payment amount. If the carbon offset is included in the payment, the TDIAM System will automatically credit the offset amount to the appropriate carbon offset company.

### 1.4.6 Calendar Component for Base Units of Inventory

As previously stated, the base unit of inventory for the chauffeured transportation vertical is the vehicle and the driver who operates the vehicle during a variable period of time. The vehicle is further classified into a vehicle type (e.g., sedan, sport utility vehicle, 6 passenger limousine, 8 passenger limousine, environmentally responsible vehicle, etc.) with relevant run time parameters associated with the maximum number of passengers and bags permissible for each vehicle type. To keep track of availability, each unit of inventory is assigned a 24 hour calendar. If the road geometry for a given geography is not present in the GIS, each supplier must classify each hour of availability on the calendar as occurring in up to five traffic speeds.

As each reservation is confirmed, the calendar of the applicable base unit of inventory is blocked for the estimated drive time, including the time associated with any stops, the minutes prior to pickup time the vehicle must be on location, and staging time, if applicable, thereby eliminating availability for that unit of time. As additional reservations are confirmed, additional time slots for that inventory unit are blocked off on the calendar, resulting in no availability for that unit of inventory during the applicable time slots.

Confirmed reservations for Hourly Service will result in the minimum number of hours blocked off starting from the pickup time or a greater number of hours as specified in the reservation request message. Whenever a unit of inventory is known to be unavailable in advance of a service date(s), the applicable periods of time should be blocked on the calendar as unavailable.

Reservation changes are further classified as inventory related or non-inventory related. An inventory related change may involve changes to the vehicle type, a change in the assigned chauffeur (e.g., as a result of a chauffeur preference), a material change to the pickup or drop off time and/or the pickup and drop off location, a material change in the number of passengers or bags, or a change in a supplier's service location (e.g., a trip is farmed out to a partner in a nearby city). Reservation changes involving non-inventory related changes do not require processing by the Inventory Management Application.

Changes involving inventory dependencies may require return of availability for the original unit of inventory to specific time slots, and blocking of availability for another unit of inventory to accommodate the requested change (i.e., a cancel/rebook of the reservation). Changes involving inventory may require a minimum lead time to make the change; without this minimum lead time the reservation change request can be denied.

Cancellations will require return of availability for the original unit of inventory to the applicable time slots. Cancellations also typically require a minimum lead time to process the cancellation; without this lead time, the cancellation request can be denied.

Note that farm out and affiliate inventory are managed in the same manner as owned inventory. A simple algorithm that spreads reservations equitably across all relevant and available units of inventory is optional to ensure a fair workload distribution on reservation requests received from all channels.

An additional dimension of inventory is needed, however, in the case of Shared Ride Service. For this type of service, pricing can be affected by the actual number of passengers who have reservations associated with the same vehicle during the same period of time. For this reason, a Shared Ride Service reservation must result not only in blocking off availability for the vehicle on the Calendar for the required period of time but also in the creation of a passenger count and a bag count that can vary from 0 to the maximum passenger and bag capacity of the vehicle type. These passenger and bag counts are incremented and decremented as new reservations, inventory related changes, and cancellations occur and also used by the pricing algorithms to increment and decrement pricing.

### 1.4.7 Proprietary Pricing and Availability Algorithms

Two methods for calculating pricing are considered to facilitate presentation of an accurate, all inclusive price quote at time of availability and reservation request processing, and to support settlement at time of reservation of the quoted trip price based on the preferred method of payment. In both cases, the estimated drive time is used as the basic unit of inventory and the basis for calculating the trip price. The two methods are 1.) use of an off the shelf GIS software package and a pricing factor by minute of drive time, and 2.) in cases where the GIS is offline and not available or the GIS does not contain the road geometry for a given geography but does contain points of interest that are geocoded, patent pending proprietary algorithms are used to compute drive time and price.

Two conditions must be met to use the proprietary pricing and availability algorithms. First, the GIS must either be offline or lack the road geometry for the given geography such that drive time is not readily available from the GIS. Second, the availability and reservation request messages must include pickup and drop off locations that either are already geocoded or that can be geocoded using the GIS.

### 1.4.7.1 Use of Minkowsky and Cartesian Geometry in Proprietary Algorithms

The patent pending proprietary algorithms use Minkowski Geometry in an innovative manner to calculate drive time and other variables. This form of geometry uses three dimensional, Spherical Coordinates to define the space where the position of a point is specified. The use of three coordinates results in more accurate calculations of the distance between two points on a sphere (e.g., the earth) since Spherical Coordinates take into account the curvature of the sphere. Minkowsky Geometry also allows for a fourth, intangible dimension to permit calculation of the time it takes to move between two points in space-time. Within the Inventory Management Application, this fourth dimension enables the calculation of drive time using well understood geometric formulas.

In the absence of a GIS that has mapped the requisite road geometry but still has all relevant points of interest geocoded, this approach can still provide a reasonably accurate estimate of drive time and support the ability to search for and retrieve existing reservations and price the trip. The distance calculations, however, do not take into account the actual road geometry but rather measure the distance between two points “as the crow flies,” or as a straight line. This approach can introduce error when the actual road geometry significantly deviates away from this geometry. For example, when the pickup and drop off points are separated by natural barriers such as lakes, rivers, or mountains, there can be significant error introduced in the calculation of drive time and distance.

In contrast, most commercially available GIS Systems use two-dimensional Euclidian or Cartesian coordinates primarily because of their need to render relatively small maps in two dimensions. Two-dimensional Cartesian Coordinates do not take the curvature of the earth into account when calculating the distance between two points. There are good reasons for this approach. Consumer devices that display these maps are generally not capable of rendering three-dimensional maps nor are the consumers generally in need of viewing three dimensional maps since the maps rendered by consumer devices typically present relatively short distances. The error introduced in calculating the distance between two points using two dimensional Cartesian coordinates is not material over short distances. (Note that it is possible to convert Cartesian Coordinates into Spherical Coordinates using standard formulae to eliminate this error.)

In addition, GIS Systems like Google Maps and ESRI also use measurements taken by laser and GPS equipped vehicles to map actual road segments in a given geography. These map coordinates are then stored in the GIS along with historical traffic speed information to support “network analysis” of alternative routes, determination of the “least cost” route, and calculation of driving distance and drive time using that specific route versus just two or three points on a two-dimensional or three-dimensional map. In the past, professional chauffeurs have not typically used a GIS to make decisions about how to optimize their route for a given trip. Rather, they use their own knowledge of the geography and current traffic conditions to make judgment calls on what route to use.

The level of precision afforded by Google's mapping approach and related driving distance and drive time calculations is, therefore, less useful to the chauffeured transportation industry than it is to the average consumer. As more and more mature GIS Systems incorporate both historical and real-time traffic information to create “predictive traffic information,” and provide automatic, intelligent routing around traffic incidents and congestion, however, this behavior is likely to change. In addition, with the advent of self-drive vehicles—Google is claiming that they will have a fully autonomous self-drive vehicle in four years—these systems will provide the navigation services. In short, with traffic congestion increasing, the use of GIS Systems and intelligent routing will become that much more important in the future.

### 1.4.7.2 Application of Four Dimensional Geometry to Proprietary Algorithms

Not all geographic areas have the road geometry represented in a GIS. In this situation, the key advantage of using Minkowski Geometry is the introduction of additional dimensions that in turn can be used to compute key pricing and availability calculations. These calculations can address the following needs of the Pricing and Availability Algorithms when responding to an availability request or reservation request:
Search Parameters—If the location and time coordinates representing the pickup and drop off locations and the pickup time are present on the inbound Availability or Reservation Request Messages, these coordinates can then be used to search for Availability or for an existing reservation that matches the trip requirements (i.e., the time and location coordinates) in the request message. This algorithm is especially useful for finding a Shared Ride trip with the availability to accept another passenger. To facilitate this search algorithm, these coordinates will be persisted as part of the history for each reservation and fulfilled trip.
Estimated Base Driving Distance—Calculations expressed as the number of degrees from the pickup point to the drop off point can be used to calculate the Estimated Base Driving Distance.
Estimated Base Drive Time—Calculations expressed as the number of degrees from the pickup point to the drop off point divided by the Average Drive Time per Degree of Angle present in the Rate Management Table can result in an Estimated Base Drive Time. If the available coordinates are associated with a Geography Exception Flag, then this calculation can only be performed accurately by a GIS System like Google and ESRI that maps actual road segments and can use the road geometry to define the theoretical optimal route between the pickup and drop off points.

Minkowski Geometry can provide a very efficient method of searching for availability for a Shared Ride Reservation, and in doing so evaluate a slight deviation in pickup location for an additional reservation to make sure that its impact on drive time is acceptable. In addition, time and location coordinates expressed as the number of degrees from the pickup point to the drop off point can serve as a foreign compound key for parameters like Return Leg Percentage

### Probability.

A TDIAM System that requires location aware services to perform drive time and driving distance calculations and to render maps of relatively small geographic areas require these coordinates. As a result, this conceptual design assumes the availability of these coordinates to the TDIAM.

### 1.4.8 Pricing Engine Component

The Pricing Engine Component uses the run time parameters in the Rate Management Table, in the Service Geography Additional Charges Table, and in the Local Tax Table, and applies these parameters either to the result set returned by the GIS System or by the proprietary algorithms to generate a Price Quote as part of an Availability or Reservation Response Message. This information is required for all Availability and Reservations transactions. Pricing strategies supported by the algorithms of this component will include Airport Transfers, Point-to-Point Transfers, Hourly Rates, Shared Ride Rates, Flat Rates (i.e., where drive time is not factored into the trip price), and Percentage or Fixed Cost Discounts Off of Base Rates.

### 1.4.9 Personalization Component

The Personalization Component stores an individual consumer's historical buying behaviors and preferences (e.g., John Smith chose a Sport Utility Vehicle for his last four consecutive trips regardless of the number of passengers or bags). The base Inventory Management Application can take advantage of this data base to provide more relevant information in response to Availability Requests, but only when the individual consumer is recognized in that data base as a result of a unique identifier present in the payload of the inbound Availability Request Message.

Personalization data bases also typically require calculation of the probability that a given consumer will purchase offers not present in the historical data base so that only offers relevant to an individual consumer are presented at time of Availability Request processing. Personalization software packages that can perform these calculations often take advantage of advanced statistical methods, such as Bayesian Probabilities, that can make inferences based on sparse data. To protect capacity and response time during peak processing periods, these calculations will be performed in batch procedures during off peak processing periods and, if needed, on separate capacity.

### 1.4.10 Interactions with the Reservations Application

The Reservations System submits Availability and Price Quote Requests to the base Inventory Management Application and to the Pricing Engine Component and receives back multi-supplier Availability and Price Quote Response Messages.

### 1.4.11 Interactions with the Customer Relationship Management (CRM) Application

The CRM Application stores passenger, corporate account, and travel intermediary profiles and related run time parameters by supplier that can affect Availability and Reservation Response Requests and Price Quotes. When calculating Price Quotes, the Pricing Engine Component of the base Inventory Management Application first checks for any discounts associated with a corporate account or passenger profiles. It can then apply any relevant discounts or flat rates to the hourly or transfer rates.

To retrieve these discounts from the relevant profiles, the required unique identifiers must be present in the payload of the inbound Availability and Reservation Request Messages (i.e., account number, passenger id number, and travel intermediary number). If these identifiers are present, the base Inventory Management Application will submit a request to the CRM Application to retrieve the relevant run time parameters from the applicable profiles and an additional request to the Personalization Data Base Component for any relevant insights into past buying behavior and preferences. This information is then used to refine the contents of the Availability Response Message, thereby assisting the consumer and/or travel intermediary (including direct channel partners merchandizing chauffeured transportation) in reviewing more personalized content and making a more informed travel buy decision.

The CRM also stores profiles for each suppler containing the relevant business rules and run time parameters governing how certain supplier centric transactions (e.g., Waybill Transaction Request Message and Push Transaction Request Message) are triggered (i.e., event driven versus time driven, etc.).

### 1.4.12 Process Flows for TDIAM Core Transactions

### BRIEF DESCRIPTION OF THE FIGURES

FIG. 1 shows a summary level conceptual design of the TDIAM Application for the chauffeured transportation industry.

FIG. 2 describes the process flows illustrating the steps required to process the Availability Request Transaction.

FIG. 3 illustrates the process flows describing the steps required to process the Reservation Request Transaction.

FIG. 4 shows the process flows illustrating the steps required to process the Reservation Change Request Transaction.

FIG. 5 represents process flows illustrating the steps required to process the Reservation Cancellation Request Transaction.

FIG. 6 describes the process flows illustrating the steps required to process the Job Closeout and Reconciliation Transaction.

FIG. 7 illustrates the process flow showing the steps to process the Reservation Retrieval Transaction.

FIG. 8 shows a process flow illustrating the steps to process the Waybill Transaction.

FIG. 9 describes a summary level technical architecture diagram for the TDIAM System. The TDIAM must support the service levels for availability, reliability, and response time expected by global channels. Application Infrastructure platform selection and the design of the Services Oriented Architecture will carefully consider this requirement.

FIG. 10 presents a summary level distribution strategy for the TDIAM System and Chauffeured Transportation. Distribution channels will include the traditional global distribution systems and other indirect channels, to include the following:

FIG. 11 illustrates a typical itinerary involving multi-modal surface transportation.

FIG. 12 shows the plight of the business and leisure traveler in trying to understand their surface transportation options.

FIG. 13 presents an overview of the Revenue Management and Marketing Automation Applications.

FIG. 14 features a typical travel industry marketing strategy.

FIG. 15 illustrates a typical travel industry customer segmentation scheme, with the four major segments broken down further into sub-segments or micro markets.

FIG. 16 presents examples of rational pricing and explains why they are rational. Section 2 presents a detailed description of each of these transactions.

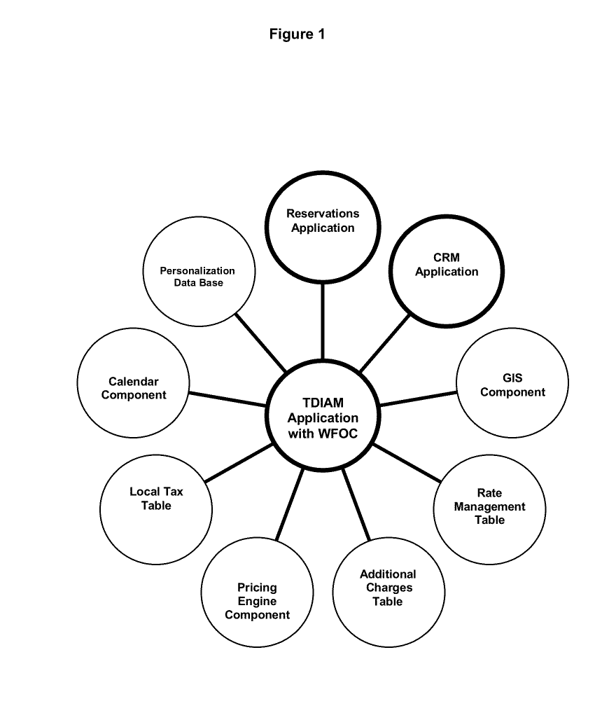

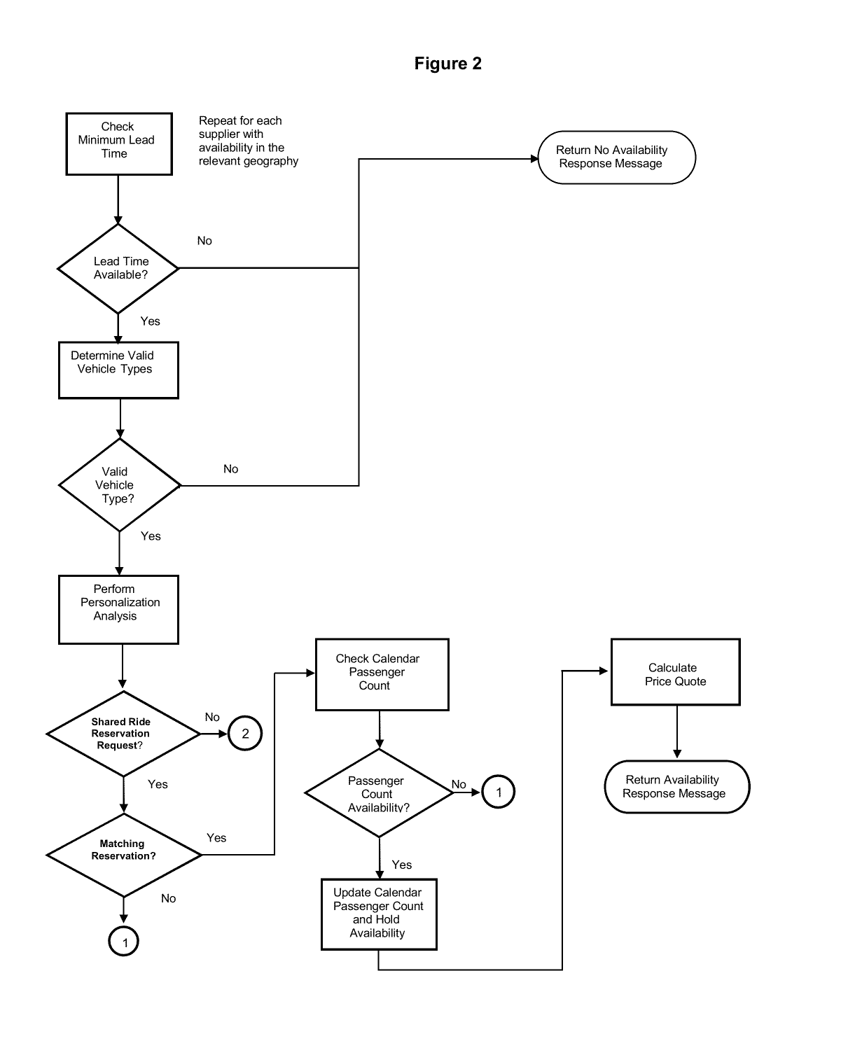

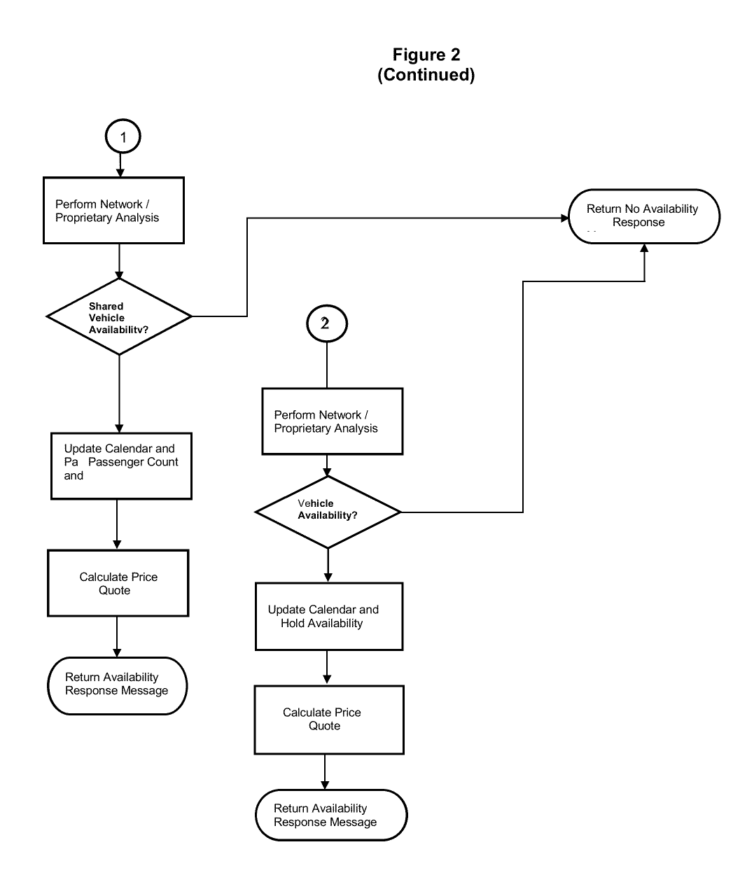

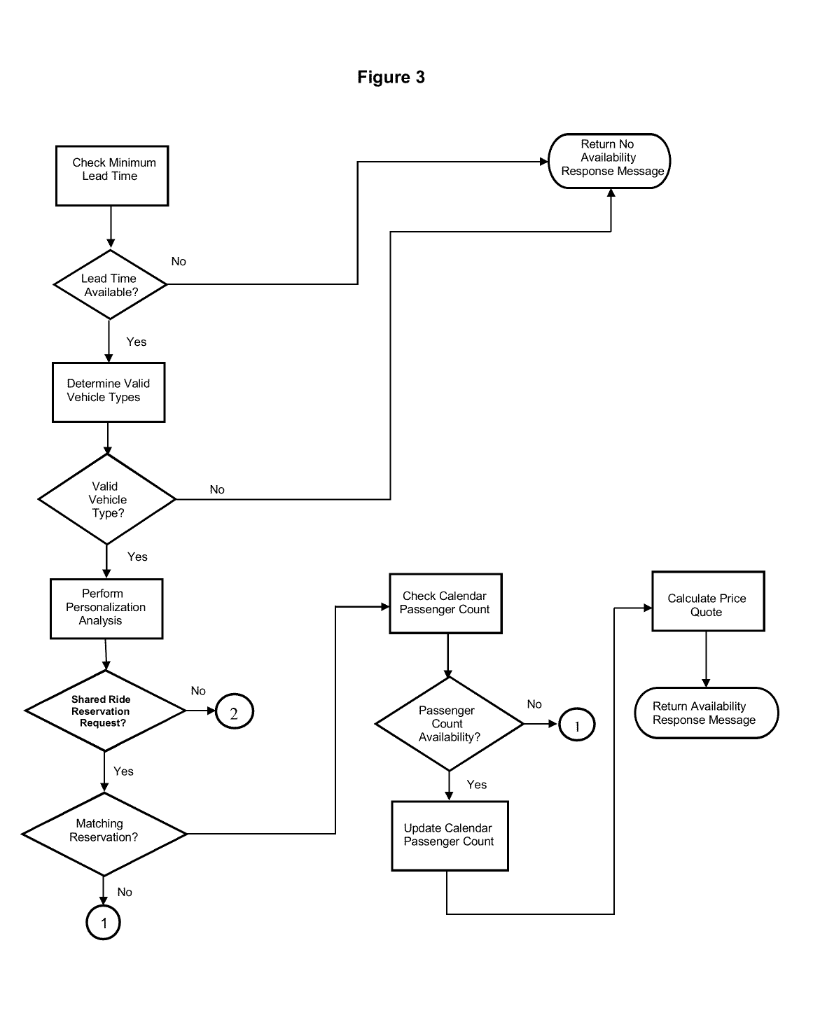

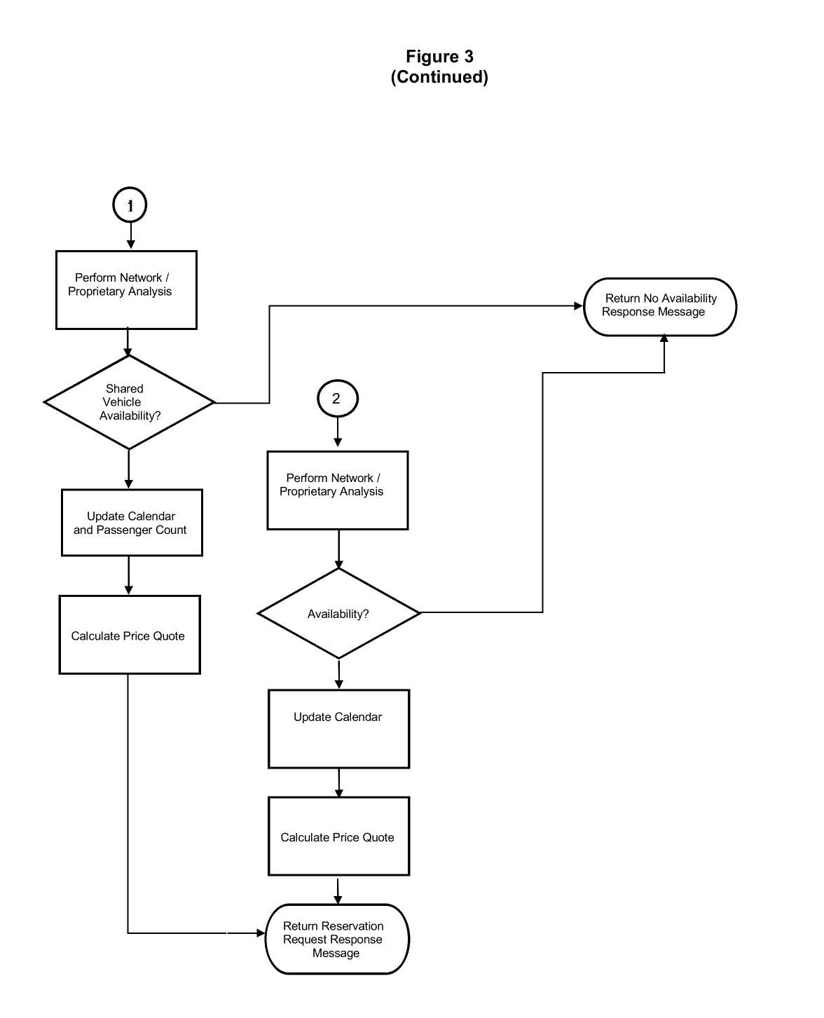

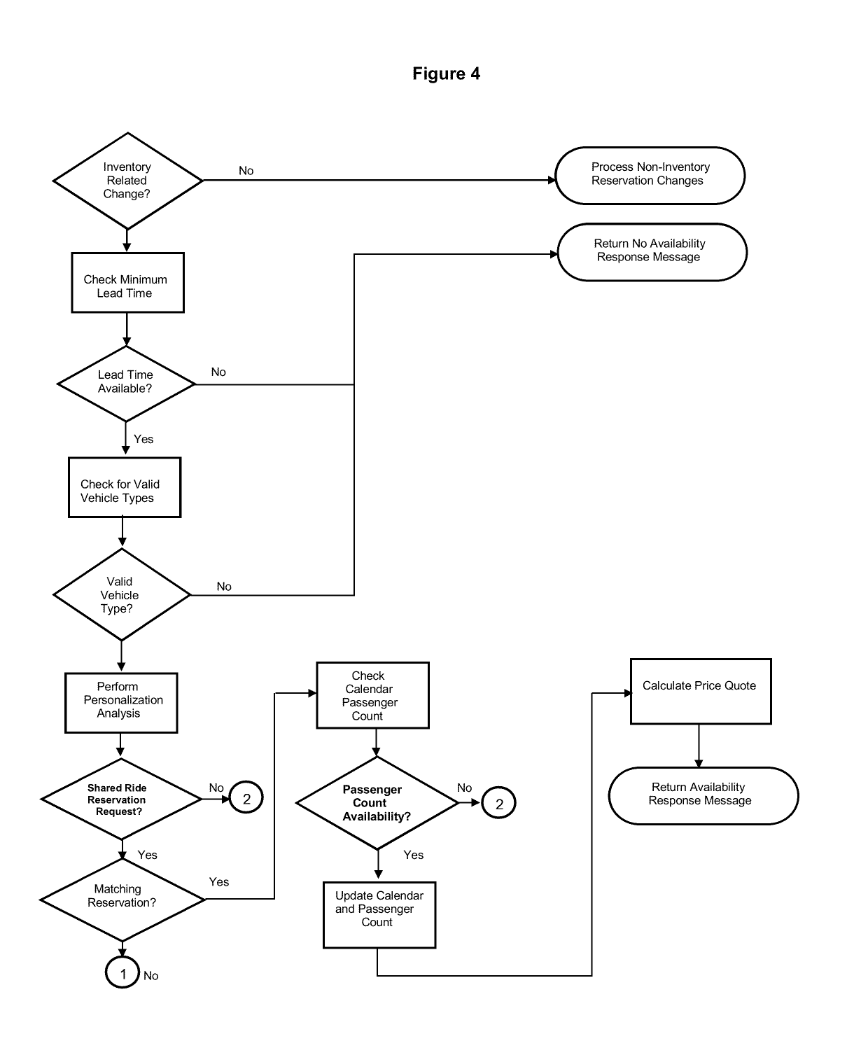

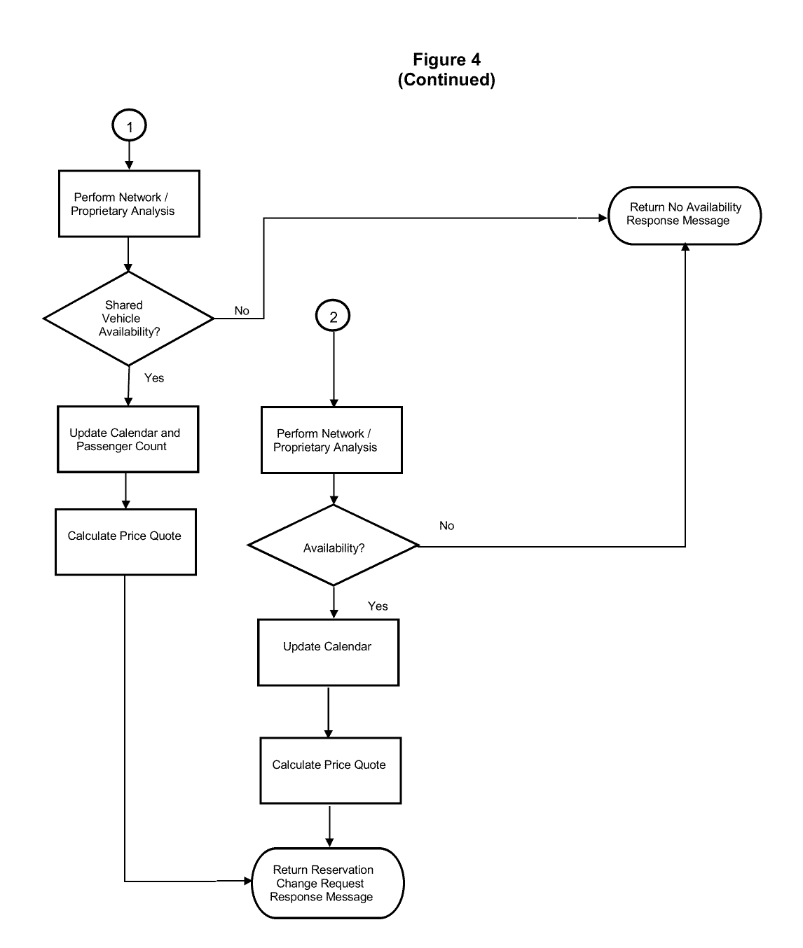

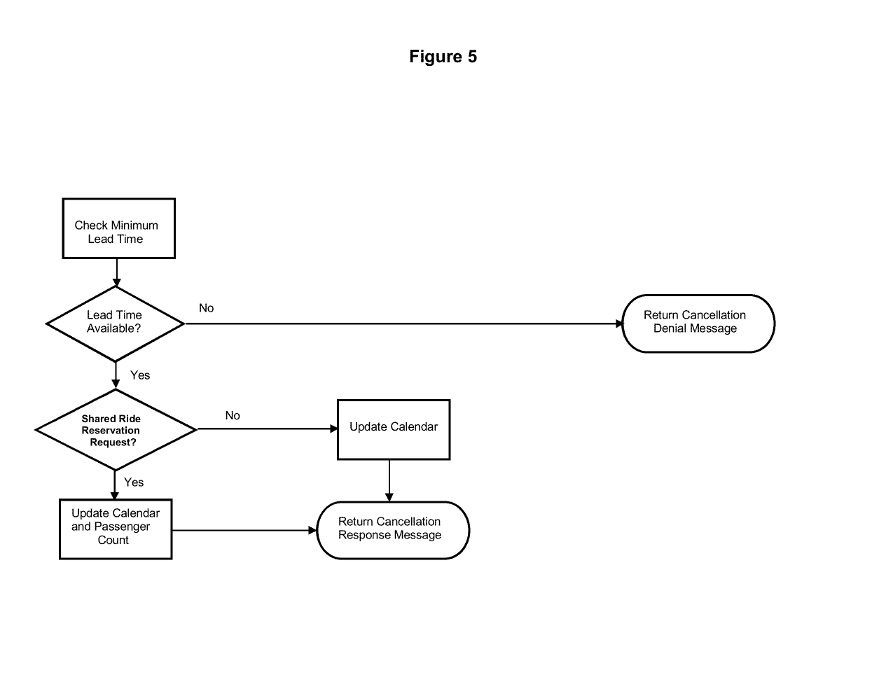

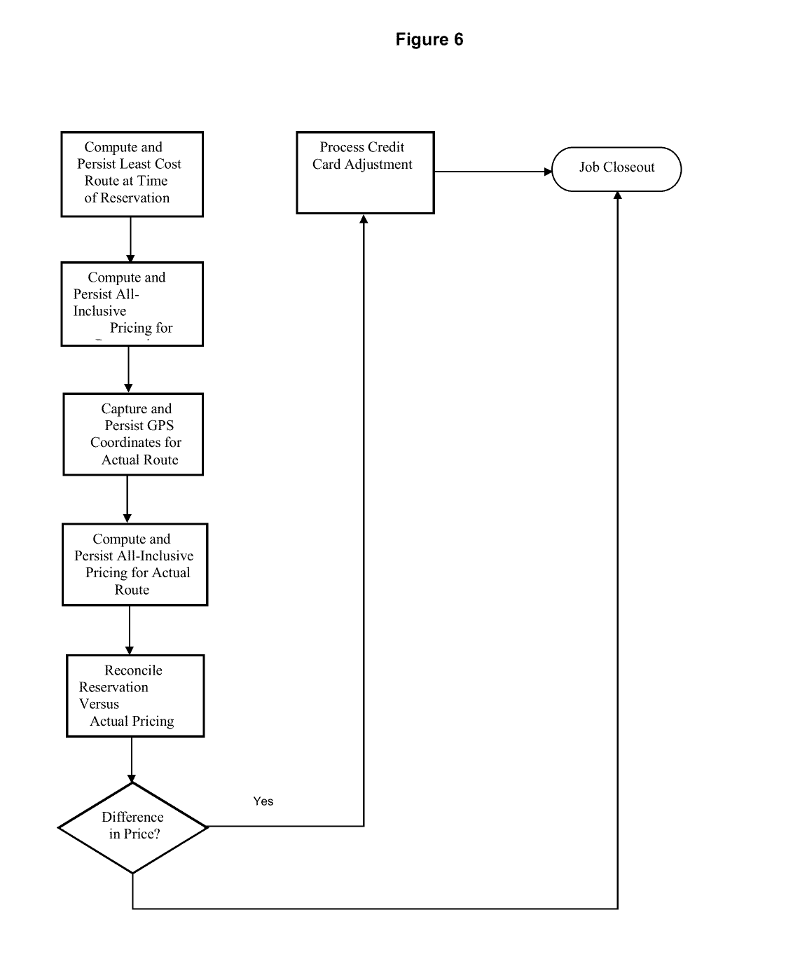

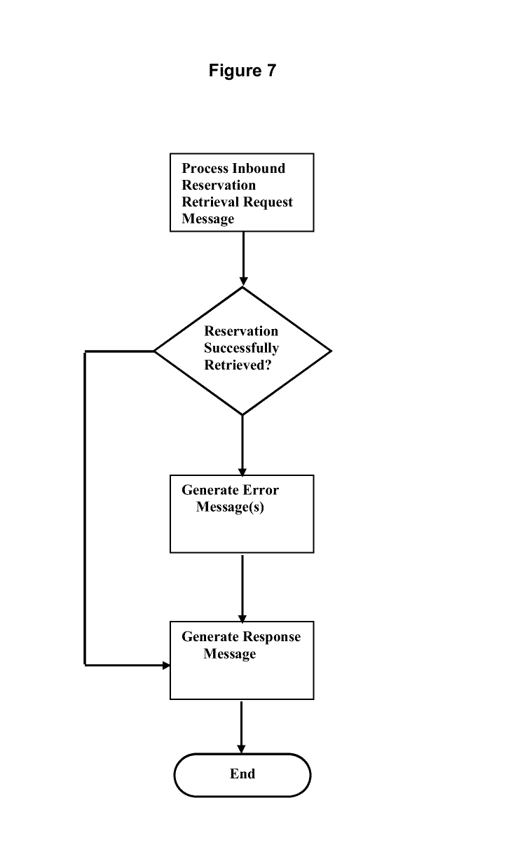

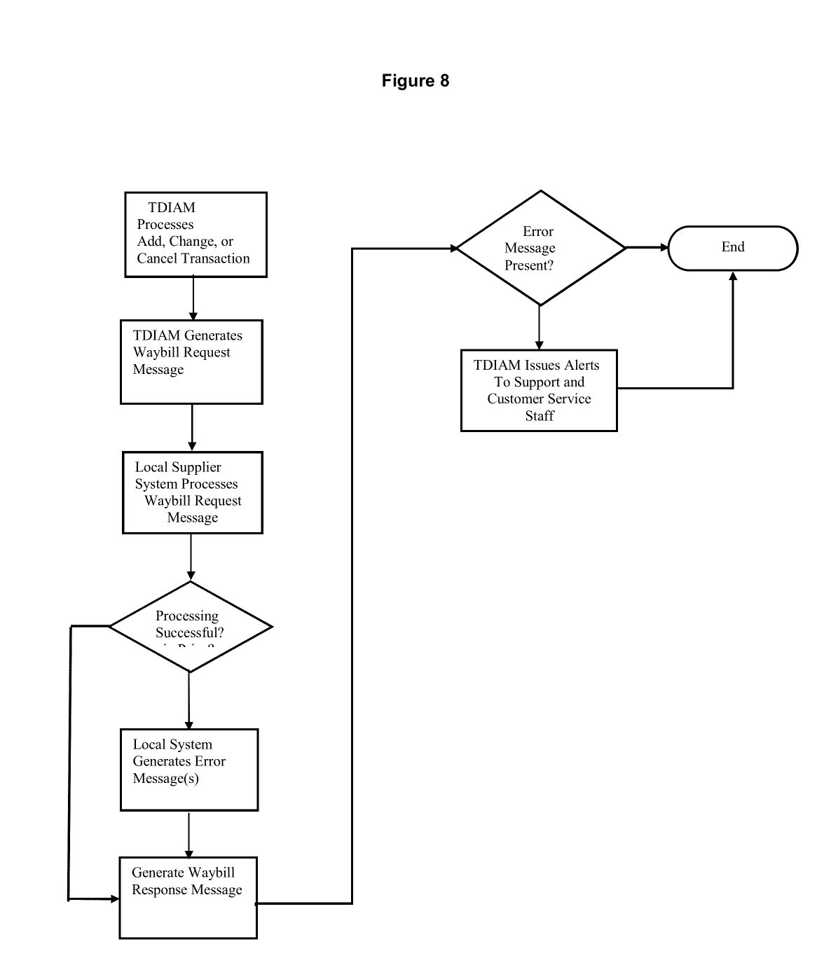

### 1.4.13 HIGH LEVEL TECHNICAL ARCHITECTURE

Consistent with sound software design practices, all applications comprising the TDIAM will be designed and constructed as an integrated set of discrete, loosely coupled components that are linked by a common messaging strategy and coordinated by a work flow orchestration software component present in the base Reservations and Inventory Management Applications. Each software component will be designed to follow the principle of “separation of concern” and focus on a limited number of functions. By following these principles and best practices, software reuse will be maximized and the cost, risk, and time to revenue for the TDIAM Application will be reduced.

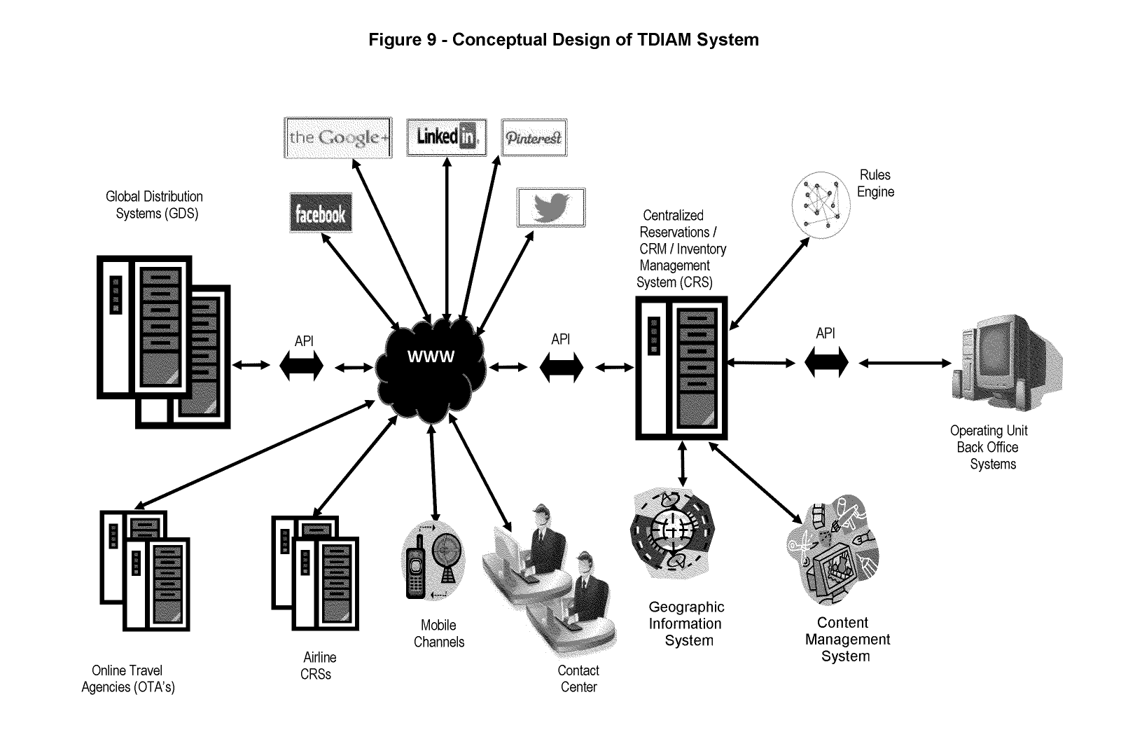

In FIG. 9, there is shown a summary level technical architecture diagram for the TDIAM System. The TDIAM must support the service levels for availability, reliability, and response time expected by global channels. Application Infrastructure platform selection and the design of the Services Oriented Architecture will carefully consider this requirement.

### 1.4.14 Persistence and Work Flow Requirements for TDIAM System

The automation and flexibility promised by using a GIS and Minkowsky Geometry will only be realized if the Persistence Service is designed to cache key parameters in the data base cache and/or in the available memory cache on the application server. This caching strategy will reduce the amount of I/O processing between the application and data base servers and between the application servers and the GIS System. Execution of these algorithms is expected to reach very high volumes when responding to global channels so it is critical to conserve computing resources wherever possible by persisting key, frequently accessed input parameters in both the data base and server caches. In addition, a work flow orchestration layer designed to optimize execution of these algorithms should ensure that server and data base cache are checked first before invoking calls to the data base or to the GIS System.

Examples of key input parameters that would be desirable to persist in cache include the following
Spherical and Cartesian Coordinates for Frequent Pickup and Drop Off Locations—Spherical and Cartesian Coordinates for Transportation Centers, Hotels, and other popular Points of Interest could be persisted in server or data base cache. The actual values of these coordinates are not volatile. Many GIS Systems offer subscriptions to Points of Interest Data Bases that would be more cost effective than high volume, repetitive calls to a GIS System.
Spherical and Cartesian Coordinates for Theoretical Service Area Center Points—Both sets of coordinates should be cached for these locations.
Parameters in Rate Management and Service Geography Additional Charges Tables—Key runtime parameters from both tables needed to compute the drive time, pricing, and availability for frequent pickup and drop off locations also should be cached.
Drive Time and Driving Distance for Template Reservations—The Drive Time and Driving Distance for transfers between transportation centers and other already cached points of interest could be cached to drive additional calculation efficiencies.

For all functions requiring access to a GIS System, major efficiencies can be gained if the GIS data base can be split up into partitions across servers, and only the partition(s) and network analysis functions required to process actual transactions are cached. Mature GIS Systems like Oracle Spatial include many of these efficiencies and will be seriously considered for their performance and programmer productivity benefits.

Personalization is another area requiring efficient design. Most software packages providing personalization functions complete their compute intensive processing in offline overnight batch procedures that sift through reservation history information to assess the probability of individual customers accepting various upsell and down sell offers. By doing this heavy lifting offline and at night, critical response time service levels are protected during peak processing periods. Similarly, Job Closeout and Reconciliation processing could be deferred to off peak processing periods to protect service levels during peak periods.

There are many more efficiencies to be realized by further optimization of the persistence and work flow services. These considerations will be addressed in more depth during the detailed design phase of the project.

### 1.4.15 Summary Level Distribution Strategy

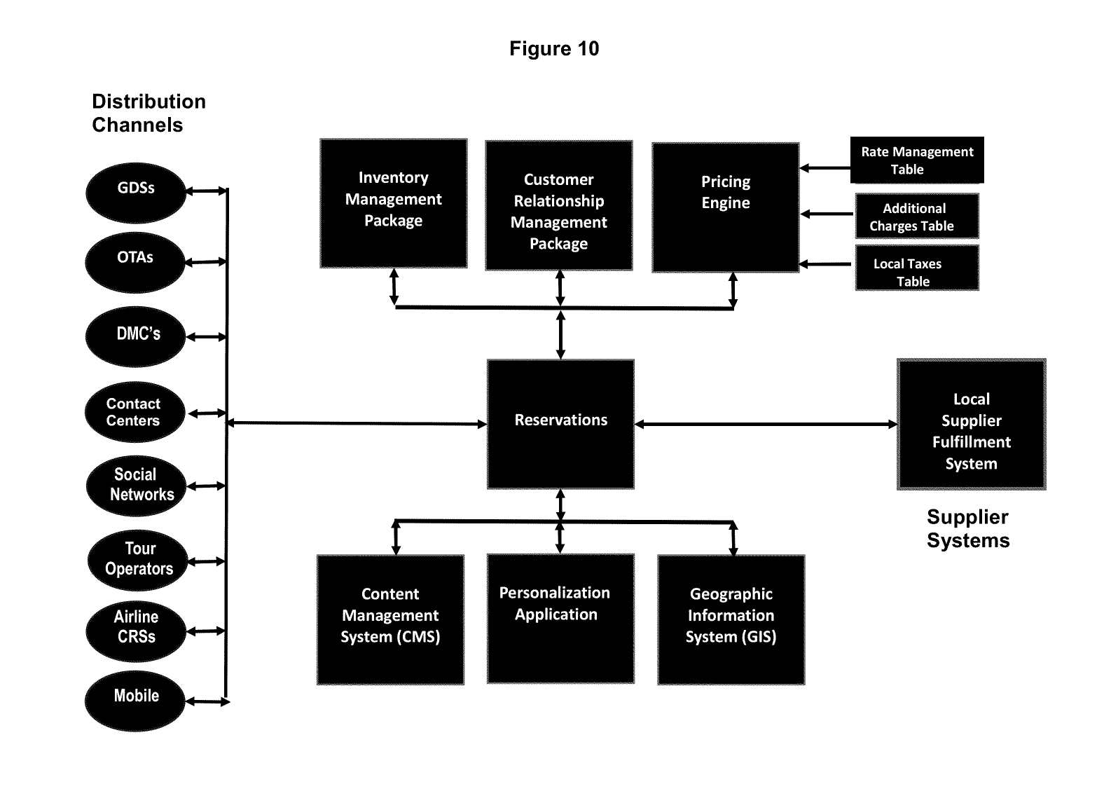

The inventory management and pricing algorithms will support distribution for both pre-planned and on demand service. The distribution strategy will include indirect and direct channels and provide functional parity across channels, empowering the individual consumer to select their channels of choice for shopping and booking chauffeured transportation. Access to this inventory will be available to traditional travel intermediaries like Travel Management Companies (TMC's) as well as direct to the individual consumer over direct channels. FIG. 10, presents a summary level distribution strategy for the TDIAM System and Chauffeured Transportation. Distribution channels will include the traditional global distribution systems and other indirect channels, to include the following:
GDSs—Sabre, Travelport, Amadeus,
Online Travel Agencies (OTAs)—Expedia, Orbitz, Travelocity,
Online Booking Tools—Concur Cliqbook and Sabre Holdings' GetThere.com,
Airline Central Reservations Systems (CRSs)—American Airlines, Delta Airlines, United Airlines, U. S. Airways, etc.
Tour Operators,
Contact Centers.

In addition to these indirect channels, the TDIAM System distribution channel strategy will include direct to consumer channels to include internet sites, mobile applications, and social networking applications. Today, approximately 35 percent of supplier interactions with customers occur via consumer direct channels. By 2015, this percentage is expected to increase to up to 65 percent of customer interactions.

The inventory management and pricing algorithms also will enable a seamless transition to self-drive vehicles and shared mobility solutions. The key guiding principle underlying the distribution strategy is to provide consumers with choice, empower them with the information to make a personally relevant, informed travel buy decision, and thereby drive improved customer satisfaction.

To be effective in solving the problems facing large metropolitan areas in the future, public sector transportation providers will need to evolve their business models to embrace the best practices followed by private sector transportation businesses. It is assumed that appropriate public sector transportation solutions will also participate in these distribution strategies and that the search and booking methods for these alternatives will be consistent with the equivalent private sector methods. The TDIAM System will thereby enable placement of all surface transportation solutions on global channels. Consumers will be empowered to choose the solutions that best meet the needs of their itinerary. Over time, all transportation solutions will benefit and improve their service offerings as a result of direct consumer interaction with distribution channels that make it easy to search and book all forms of surface transportation. In the “President's National Technology Investment Report,” Erik Schmidt of Google recommended that the Top Two Investments Priorities be Artificial Intelligence and Vehicle Automation. Disruptive business models in the transportation industry—Zip Car, Uber, Lyft, Sidecar, and Flightcar to name the most well known examples—are being fueled by the recession, the public internet, the social networking sites, and the resulting increased willingness on the part of consumers to do business with “Strangers”. These developments and the pressing socio-economic problems facing large metropolitan areas mandate more effective distribution solutions for all forms of public and private sector surface transportation. Extensive public, academic, and commercial sector research is underway to help solve these problems, but the practical aspects of building effective distribution systems for surface transportation are noticeably absent from most of this research.

### 2. Detailed Algorithms Required to Process TDIAM Transactions

The following sections present a definition for the term “algorithm” and document the specific algorithms required to process Availability and Reservations transactions for the chauffeured transportation industry.

### 2.1 Definition of an Algorithm

As a preface to definition of the key TDIAM Application algorithms and to create a common understanding of what an algorithm is, what it requires, and how it works, this introductory section will cite the following excerpt from a broader online discussion of algorithms and how they work within computer applications.

“An algorithm specifies a series of steps that perform a particular computation or task. Algorithms were originally born as part of mathematics—the word “algorithm” comes from the Arabic writer Muhammad ibn Mūsā al-Khwārizmī,—but currently the word is strongly associated with computer science.
An algorithm has the following properties:
An algorithm is an unambiguous description that makes clear what has to be implemented.
An algorithm expects a defined set of inputs.
An algorithm produces a defined set of outputs.
An algorithm is guaranteed to terminate and produce a result, always stopping after a finite time.
Most algorithms are guaranteed to produce the correct result.
If an algorithm imposes a requirement on its inputs (called a precondition), that requirement must be met. For example, a precondition might be that an algorithm will only accept positive numbers as an input. If preconditions are not met, then the algorithm is allowed to fail by producing the wrong answer or never terminating.”

The following sections will present the key algorithms needed to process availability and reservations transactions within the TDIAM Application for the chauffeured transportation industry. The required preconditions, set of inputs, set of outputs, and process steps that must be implemented will be defined for each algorithm.

### 2.2 Availability Request Transaction Algorithm

The Reservation Application submits an Availability Request Transaction to the Inventory Management Application as a result of receiving an Availability Request Message from a channel partner or a contact center agent (i.e., an agent in a call center or in a dispatch office). The Inventory Management Application uses the required inputs provided by the Reservation Application and other Inventory Management Application components to determine if there is relevant inventory available to fulfill the Availability Request based on contextual information in the inbound Availability Request Message and personalization information available in the Personalization Data Base Component. Note that the search for availability is always assumed to be a shopping request across multiple suppliers.

If relevant inventory is available, the Inventory Management Application uses additional components to block the required availability temporarily for a specified period of time (e.g., 45 seconds), generate a price quote for the applicable inventory options, and return an Availability Request Response Message with the required outputs to the Reservation Application. If relevant inventory is not available, the Inventory Management Application will return an Availability Request Response Message with the required outputs and a message that no availability exists for the service requested in that geography for the pickup date and time.

The following sections identify the required preconditions, inputs, outputs, and discrete process steps that must be implemented for the Availability Request Transaction Algorithm.

### 2.2.1 Required Pre-conditions, Inputs, and Outputs for Availability Request Transaction Algorithm

The required pre-condition for this transaction is submission of a valid inbound Availability Request Message by the Reservation Application containing the required inputs. The required inputs in a valid inbound Availability Request message include the following:
Service type (i.e., airport transfer, point-to-point transfer, hourly service, shared ride service, group transfer, group charter, etc.),
Number of passengers,
Number of bags,
Account identification number (if corporate discounts and preferences apply),
Lead Passenger identification number (if lead passenger opts in to receiving personalized availability, options, pricing, and other offers), Travel intermediary number (if availability request is submitted by an intermediary and if pricing rules require up front disclosure of commissionable versus non-commissionable rates),
Valid pickup address,
Valid stop address(es),
Pickup address Cartesian Coordinates,
Stop address(es) Cartesian Coordinates,
Valid drop off address (except for Hourly Service),
Drop off address Cartesian Coordinates,
Valid pickup date and time with time zone offset from Greenwich Mean Time (GMT),
Valid flight number (or tail number) and carrier (for airport or FBO pickups)

The required outputs in a valid Availability Request response message include the following:
Supplier code(s),
Requested service type,
Number of passengers,
Number of bags,
Relevant vehicle type code(s),
Corporate account number,
Lead passenger identification number,
Intermediary identification number,
Price quote for each vehicle type,
Price quote for each unbundled ancillary service (e.g., greeter service, stops, and other services),
Price quote disclaimer details,
Date of service,
Pickup time with time zone offset from GMT,
Requested drop off time,
Estimated drive time and distance,
Pickup location,
Drop off location (except for hourly service),
Change and Cancellation rules,
Other terms and conditions,
Error Message(s).
   The following sections define the discrete processing steps that must be completed as part of an Availability Request Transaction Algorithm.

### 2.2.2 Processing Steps for Availability Request Transaction Algorithm

The following steps must be completed as part of the Availability Request Transaction Algorithm. The breakdown of the processing steps and their sequencing is not meant to imply a serial approach to the work flow of the algorithm. Some of these steps could potentially be performed simultaneously.

### Step 1: Check for Minimum Lead Time to Accept a Reservation Request

Each supplier must decide what type of service they choose to offer in a given Service Geography, to include on demand service (no lead time required to book) and pre-planned service (variable lead time required to book). If the requested pickup time is immediate and the supplier does not deliver on demand service, or if the pickup time does not support the lead time specified for confirming pre-planned service, then an Availability Request Response Message will be returned indicating that there is no availability.

### Step 2: Determine Valid Vehicle Types.

Determine valid vehicle types based on contextual information in the inbound Availability Request Message—i.e., number of passengers and bags. If the supplier does not have a valid vehicle type, then an Availability Request Response Message will be returned indicating that there is no availability.

### Step 3: Perform Personalization Search

If present in the inbound Availability Request Message, use the lead passenger id to search the personalization data base component for historical buying behaviors and preferences. Compare the capacity of vehicle types found in the personalization data base with the capacity of the valid vehicle types identified in Step 1 and count valid vehicle types used in past reservations. Identify ancillary services requested in past reservations (e.g., greeter services).

### Step 4: Calculate the Estimated Drive Time and Hold Relevant Availability Adding Passenger(s) to Shared Ride Service

If the Availability Request Message seeks to add one or more passengers to an existing shared ride reservation, then the Reservation Application initiates a search using either the Cartesian or Spherical Coordinates of the pickup location, the coordinates of the drop off location, and the pickup time in the Availability Request Message. If a matching reservation is not found, then an attempt is made to book a new reservation with a shared ride vehicle. If a shared ride vehicle is not available, then the Availability Request Response Message will indicate that there is no availability.

If a matching reservation is found, the proprietary algorithms will check the passenger count and baggage count for the reservation in the Inventory Management System Calendar Component to determine availability, revise the passenger and bag counts if availability is present, and return an Availability Request Response Message. If either the passenger or baggage counts in the Calendar Component do not support the requested number of additional passengers and bags depending on whether or not there is availability for the requested number of passengers and bags then an Availability Request Response Message will be returned indicating that there is no availability.

### Geography Exception Flag Present

For transfer service, if there is a Geography Exception Flag associated with the pickup and drop off addresses, call the GIS System Network Analysis Application Programming Interface (API) and receive back the Cartesian Lat/Long Coordinates, the Estimated Drive Time, and the Estimated Driving Distance. Also returned are the Estimated Drive Time and Driving Distances from the center point to the pickup point and from the center point to the drop off point. If the road geometry is not present in the GIS, or if the GIS is offline, convert Cartesian to Spherical Coordinates as needed and use the Proprietary Algorithms. If the Proprietary Algorithms are used, drive times should then be adjusted using the Drive Time Increase Factors and other relevant run time parameters available in the Rate Management Table Component.

### Missing Coordinates

If the Geography Exception Flag is not present, but neither Spherical nor Cartesian Coordinates for the pickup and drop off addresses are present in the inbound Availability Request Message, call the GIS System address verification, geocoding, and network analysis services via Application Programming Interfaces (APIs) and receive back the Spherical and/or Cartesian Coordinates, the Estimated Driving Distances, and the Estimated Drive Times between the pickup and drop off locations, from the center point to the pickup point, and from the drop off point to the center point. If the road geometry is not present in the GIS, or if the GIS is offline, convert Cartesian to Spherical Coordinates as needed. If the Proprietary Algorithms are used, drive times should then be adjusted using the Drive Time Increase Factors and other relevant run time parameters available in the Rate Management Table Component.

### Component Drive Time Calculations

If the Cartesian Coordinates are present in the Inbound Availability Request Message and the road geometry is present in the GIS, call the GIS Network Analysis API to calculate the Estimated Drive Times and Estimated Driving Distances between the pickup and drop off locations, from the center point to the pickup point and from the drop off point to the center point. If the road geometry is not present in the GIS, or if the GIS is offline, convert Cartesian to Spherical Coordinates as needed. If the Proprietary Algorithms are used, drive times should then be adjusted using the Drive Time Increase Factors and other relevant run time parameters available in the Rate Management Table Component.

### Total Drive Time Calculation and Availability Check

Use the component drive time calculations to calculate the Estimated Total Drive Time, taking into account Stops, and inventory staging time. Check each supplier's availability for each valid vehicle type and unit of inventory and each applicable ancillary service by accessing the Inventory Management Application Calendar Component. If relevant availability is open (i.e., the total drive time is available on the calendar and the requested ancillary services also are available), for each supplier, put a temporary hold of “x” seconds on the applicable drive time period for the applicable vehicle types and units of inventory and on the applicable ancillary service(s).

Estimated Total Drive Time=((Center Point to Pickup Point Drive Time+Pickup to Drop Off Point Drive Time+Drop Off to Center Point Drive Time)*Drive Time Increase Factor)+Stops Time+Minimum Lead Time Prior To Pickup Time

### Step 5: Calculate Price Quote

### Single Passenger Transfer Service

For transfer service, use the corporate account number if present, the passenger id number if present, intermediary id number if present, and ancillary services code(s) if present, to retrieve relevant run time parameters from the Rate Management Table Component, the Service Geography Additional Charges Table Component, the Local Tax Table Component, and the CRM Application, and then perform the following pricing calculations:

Total Price=Base Price+Driver Gratuity+Cost of Empty Return Leg+Stops Charges+

Additional Charges+Sales Tax+Carbon Offset Cost+Cost of Ancillary Services

Base Price=((Drive Time*Base Unit Cost*(100−Percent Discount))

Driver Gratuity=Base Price*Driver Gratuity Percentage

Cost of Return Leg=(Cost of Empty Return Leg*(100−Return Leg Percentage Probability))

If present, use the passenger id number to search the Personalization Data Base Component for historical price elasticity and buyer behaviors and adjust offer as needed.

Submit relevant run time parameters to the Pricing Engine Component and generate a preliminary price quote by supplier. Compare the passenger's historical price elasticity patterns with the newly generated price quote(s) for each supplier. If needed, adjust price quotes per business rules at the individual supplier level of detail.

Shared Ride Transfer Service

Retrieve relevant run time parameters from the Rate Management Table Component, the Service Geography Additional Charges Table Component, the Local Tax Table Component, and the CRM Application, and then perform the following pricing calculations:

Total Price=Base Price+((Driver Gratuity+Cost of Empty Return Leg+Additional Charges+

Sales Tax+Carbon Offset Cost)/Passenger Capacity)

Base Price=(Drive Time*Base Unit Cost)+(Shared Ride Passenger Rate)

Driver Gratuity=Base Price*Driver Gratuity Percentage

Cost of Return Leg=(Cost of Empty Return Leg*(100−Return Leg Percentage Probability))

### Hourly Service

For hourly service, use the corporate account number if present, the passenger id number if present, the intermediary id number if present, and the ancillary services code if present, to retrieve relevant run time parameters from the Rate Management Table Component, the Service Geography Additional Charges Table Component, the Tax Table Component, and the CRM Application, and then perform the following price calculations:

Total Price=Base Price+Driver Gratuity+Cost of Empty Return Leg+Additional Charges+

Sales Tax+Stops Charges+Carbon Offset Cost+Cost of Ancillary Services

Base Price=(No. of Hours*Hourly Cost*(100−Percent Discount))

Driver Gratuity=Base Price*Driver Gratuity Percentage

Cost of Return Leg=(Cost of Empty Return Leg*(100−Return Leg Percentage Probability))

### Step 6: Generate Availability Request Response Message

Using the information collected in Steps 1 through 4, create an Availability Request Response Message that presents availability and pricing by supplier, vehicle type, and ancillary service (e.g., greeter service) and includes appropriate disclaimer text and terms and conditions.

### 2.3 Reservation Request Transaction Algorithm

The Reservation Application processes a Reservation Request Transaction as a result of receiving an inbound Reservation Request Message from a channel partner or a contact center agent (i.e., an agent in a call center or a dispatch office). Before the Reservation Application can confirm the reservation and any requested ancillary services, however, the Inventory Management Application must first check availability and generate a price quote for the requested vehicle type and ancillary services on the service date.

If the requested vehicle type and ancillary services are available, the Inventory Management Application must block the applicable availability on the Calendar Component, generate a price quote, and return a Reservation Request Response Message with the required outputs confirming availability to the Reservation Application. If the vehicle type and chauffeur are not available, then the Inventory Management Application returns a Reservation Request Response Message to the Reservations Application communicating that there is no availability for the requested service geography, vehicle type, ancillary services, and/or pickup date and time.

Note that the Reservation Application is assumed to support processing of multi-segment reservation transactions for trading partners who also support and prefer this design. Single segment reservation processing also is assumed to be supported. XML schemas for these transactions also will reflect support for both multi-segment and single segment reservations.

The following sections identify the required preconditions, inputs, outputs, and discrete process steps that must be implemented for the Reservation Request Transaction Algorithm.

### 2.3.1 Required Pre-conditions, Inputs, and Outputs for Reservation Request Transaction Algorithm

The required pre-condition for this transaction is submission of a valid inbound Reservation Request message by the applicable channel partner or contact center agent to the Reservation Application.

The required inputs in a valid inbound Reservation Request message include the following:
Supplier Code,
Service type (i.e., airport transfer, point-to-point transfer, hourly service, shared ride, group transfer, group charter, etc.),
Vehicle type,
Number of passengers,
Number of bags,
Ancillary service(s) id(s),
Account identification number (if corporate discounts and preferences apply),
Lead passenger identification number (if lead passenger opts in to receiving personalized availability options, pricing, and other offers),
Travel intermediary number (if availability request is submitted by an intermediary and if pricing rules require up front disclosure of commissionable versus non-commissionable rates),
Valid pickup address,
Valid stop address(es),
Pickup address Cartesian Coordinates
Stop address Cartesian Coordinates,
Valid drop off address (except for Hourly Service),
Drop off address Cartesian Coordinates,
Valid pickup date and time with time zone offset from Greenwich Mean Time (GMT),
Valid flight number (or tail number) and carrier (for airport or FBO pickups)

The required outputs in a valid Reservation Request response message include the following:
Confirmation number,
Segment number(s),
Supplier Code,
Requested service type,
Vehicle type,
Number of passengers,
Number of bags,
Corporate account number,
Lead passenger identification number,
Intermediary identification number,
Price quote for each vehicle type,
Price quote for each unbundled ancillary service (e.g., greeter service, stops, and other ancillary services),
Price quote disclaimer details,
Date of service,
Pickup time with time zone offset from GMT,
Requested drop off time,
Estimated drive time and miles,
Pickup location,
Drop off location (except for hourly service),
Change and Cancellation rules,
Other terms and conditions,
Error Message(s).

### 2.3.2 Processing Steps for Reservation Request Transaction Algorithm

The following steps must be completed as part of the Reservation Request Transaction Algorithm. The breakdown of the processing steps and their sequencing is not meant to imply a serial approach to the work flow of the algorithm. Some of these steps could potentially be performed simultaneously.

### Step 1: Check for Minimum Lead Time to Accept a Reservation Request

Each supplier must decide what type of service they choose to offer in a given Service Geography, to include on demand service (no lead time required to book) and pre-planned service (variable lead time required to book). If the requested pickup time is immediate and the supplier does not deliver on demand service, or if the pickup time does not support the lead time specified for pre-planned service, then a Reservation Request Response Message will be returned indicating that there is no availability.

### Step 2: Calculate the Estimated Drive Time and Block Availability

### Adding Passenger(s) to Shared Ride Service

If the Reservation Request Message seeks to add one or more passengers to an existing shared ride reservation, then the Reservation Application initiates a search using either the Cartesian or Spherical Coordinates of the pickup location, the coordinates of the drop off location, and the pickup time in the Reservation Request Message. If a matching reservation is not found, then an attempt is made to book a reservation with a new shared ride vehicle. If a shared ride vehicle is not available, then the Reservation Request Response Message will indicate that there is no availability.

If a matching reservation is found, the proprietary algorithms will check the passenger count and baggage count for the reservation in the Inventory Management System Calendar Component to determine availability, revise the passenger and bag counts if availability is present, and return a Reservation Request Response Message. If either the passenger or baggage counts in the Calendar Component do not support the requested number of additional passengers and bags depending on whether or not there is availability for the requested number of passengers and bags then a Reservation Request Response Message will be returned indicating that there is no availability. Even if the pickup location coordinates do not match the existing reservation but the pickup time and location for the second reservation will not materially add to drive time (based on a pre-defined threshold), assuming the passenger and baggage counts are not exceeded, then the Availability Response Message will indicate availability.

### Geography Exception Flag Present

For transfer service, if there is a Geography Exception Flag associated with the pickup and drop off addresses, call the GIS System Network Analysis API and receive back the Cartesian Coordinates, the Estimated Drive Time, and the Estimated Driving Distance, and the Estimated Drive Time and Driving Distances from the center point to the pickup point and from the center point to the drop off point. If the road geometry is not present in the GIS, or if the GIS is offline, convert Cartesian to Spherical Coordinates as needed and use the Proprietary Algorithms. If the Proprietary Algorithms are used, consider Drive Time Increase Factors and other relevant run time parameters from the Rate Management Table Component.

### Missing Coordinates

If the Geography Exception Flag is not present, but neither Spherical nor Cartesian Coordinates for the pickup and drop off addresses are present in the inbound Reservation Request Message, call the GIS System address verification, geocoding, and network analysis services via Application Programming Interfaces (APIs) and receive back the Cartesian Coordinates, the Estimated Driving Distances, and the Estimated Drive Times between the pickup and drop off locations, from the center point to the pickup point, and from the drop off point to the center point. If the road geometry is not present in the GIS, or if the GIS is offline, convert Cartesian to Spherical Coordinates as needed and use the Proprietary Algorithms. If the Proprietary Algorithms are used, drive times should then be adjusted using the Drive Time Increase Factors and other relevant run time parameters available in the Rate Management Table Component.

### Component Drive Time Calculations

If either the Cartesian or Spherical Coordinates are present in the Inbound Reservation Request Message, using the Cartesian Coordinates, calculate the Estimated Drive Times and Estimated Driving Distances between the pickup and drop off locations, from the center point to the pickup point and from the drop off point to the center point. If the road geometry is not present in the GIS, convert Cartesian to Spherical Coordinates as needed and use the Proprietary Algorithms. If the Proprietary Algorithms are used, drive times should then be adjusted using the Drive Time Increase Factors and other relevant run time parameters available in the Rate Management Table Component.

### Total Drive Time Calculation and Availability Check

Use the component drive time calculations to calculate the Estimated Total Drive Time.

Total Drive Time=((Center Point to Pickup Point Drive Time+Pickup to Drop Off Point Drive

Time+Drop Off to Center Point Drive Time)*Drive Time Increase Factor)+Stops Time+

Minimum Lead Time Prior To Pickup Time

Check the requested supplier's availability for the requested vehicle type and ancillary service(s) by accessing the Inventory Management System Application Calendar Component. If relevant availability is open (i.e., the total drive time is available on the calendar and the requested ancillary services also are available), then calculate the price quote.

### Step 3: Calculate Price Quote

### Single Passenger Transfer Service

For transfer service, use the corporate account number if present, the passenger id number if present, intermediary id number if present, and ancillary services code(s) if present, to retrieve relevant run time parameters from the Rate Management Table Component, the Service Geography Additional Charges Table Component, the Tax Table Component, and the CRM Application, and then perform the following pricing calculations:

Total Price=Base Price+Driver Gratuity+Cost of Empty Return Leg+Additional Charges+

Stops Charges+Sales Tax+Carbon Offset Cost+Cost of Ancillary Services

Base Price=(Drive Time*Base Unit Cost*(100−Percent Discount))

Driver Gratuity=Base Price*Driver Gratuity Percentage

Cost of Return Leg=(Cost of Empty Return Leg*(100−Return Leg Percentage Probability))

Submit relevant run time parameters to the Pricing Engine Component and generate a preliminary price quote by supplier. Compare the passenger's historical price elasticity patterns with the newly generated price quote. If needed, adjust offers and price quotes per business rules at the individual supplier level of detail.

### Shared Ride Transfer Service

Retrieve relevant run time parameters from the Rate Management Table Component, the Service Geography Additional Charges Table Component, the Tax Table Component, and the CRM Application, and then perform the following pricing calculations:

Total Price=Base Price+((Driver Gratuity+Cost of Empty Return Leg+Additional Charges+

Local Sales Tax+Carbon Offset Cost)/Passenger Capacity)

Base Price=(Drive Time*Base Unit Cost)+(Shared Ride Passenger Rate)

Driver Gratuity=Base Price*Driver Gratuity Percentage

Cost of Return Leg=(Cost of Empty Return Leg*(100−Return Leg Percentage Probability))

### Hourly Service

For hourly service, use the corporate account number if present, the passenger id number if present, the intermediary id number if present, and the ancillary services code if present, to retrieve relevant run time parameters from the Rate Management Table Component, the Service Geography Additional Charges Table Component, the Tax Table Component, and the CRM Application, and then perform the following price calculations:

Total Price=Base Price+Driver Gratuity+Cost of Empty Return Leg+Stops Charges+

Additional Charges+Local Sales Tax+Carbon Offset Cost+Cost of Ancillary Services

Base Price=(No. of Hours*Hourly Cost*(100−Percent Discount))

Driver Gratuity=Base Price*Driver Gratuity Percentage

Cost of Return Leg=(Cost of Empty Return Leg*(100−Return Leg Percentage Probability

### Step 4: Generate Reservation Request Response Message

Using the information collected in Steps 1 and 2, create a Reservation Request Response Message that presents a confirmation of the requested availability and pricing for the requested vehicle type and ancillary service(s) (e.g., greeter fee) and includes appropriate disclaimer text and terms and conditions. If there is no availability either for the requested vehicle type or ancillary service(s), create a Reservation Request Response Message communicating the lack of availability for the applicable vehicle type and/or ancillary service(s).

### 2.4 Reservation Change Request Transaction Algorithm

The Reservation Application processes a Reservation Change Request Transaction as a result of receiving an inbound Reservation Change Request Message from a channel partner or a contact center agent (i.e., an agent in a call center or a dispatch office).

The Inventory Management Application is involved only with reservation chances that affect inventory or pricing. This business rule protects the integrity of the automated inventory availability process as well as the accuracy of supplier billing for message fees. All other changes to the reservation are handled directly by the Reservation Application and persisted in the data base if the requested change passes all other applicable edit checks.

Examples of inventory and pricing related changes to a reservation include the following:
Changes to the requested vehicle type or chauffeur preference,
Changes to the requested ancillary services,
Change of chauffeured transportation supplier,
Changes to the service date and/or to the pickup and/or drop off times
Changes to the pickup and/or drop off locations that can affect drive time and pricing,
Change in service type from an airport or point-to-point transfer to hourly service or vice versa.

Additional business rules and terms and conditions can apply to processing a reservation change request. For example, most chauffeured transportation suppliers require a lead time in advance of the pickup time to accept a reservation change. This lead time is required to prevent assignment and dispatch of a chauffeur to a pickup location only to have the reservation changed in a way that could result in a service defect or pricing dispute. These business rules will be stored as run time parameters in the Rate Management Table Component and retrieved as part of processing the reservation change request.

Before the Reservation Application can confirm an inventory or pricing related change to a reservation, the reservation change request must be submitted to the Inventory Management Application to accomplish the following actions:
Check on the availability of any newly requested vehicle type or ancillary service(s) and hold this availability if open.
Re-calculate the drive time and price quote,
Create a Reservation Change Request response message that either confirms the requested changes or communicates the lack of availability for the requested vehicle and/or ancillary service(s).
Return inventory availability for any vehicle type or ancillary services no longer needed to fulfill the reservation,
   The following sections identify the required preconditions, inputs, outputs, and discrete process steps that must be implemented for the Reservation Request Transaction Algorithm.

### 2.4.1 Required Pre-conditions, Inputs, and Outputs for Reservation Change Request Transaction Algorithm

The required pre-condition for this transaction is submission of a valid inbound Reservation Change Request Message by the applicable channel partner or contact center agent to the Reservation Application.

The required inputs in a valid inbound Reservation Change Request Message include the following:
Reservation confirmation number,
Segment number(s),
Supplier code,
Service type (i.e., airport transfer, point-to-point transfer, hourly service, group transfer, group charter, etc.),
Vehicle type,
Number of passengers,
Number of bags,
Ancillary service(s) id(s),
Account identification number (if corporate discounts and preferences apply),
Lead passenger identification number (if lead passenger opts in to receiving personalized availability options, pricing, and other offers),
Travel intermediary number (if availability request is submitted by an intermediary and if pricing rules require up front disclosure of commissionable versus non-commissionable rates),
Valid pickup address,
Valid Stop address(es),
Pickup address Cartesian Coordinates,
Stop address(es) Cartesian Coordinates,
Valid drop off address (except for Hourly Service)
Drop off address Cartesian Coordinates,
Valid pickup date and time with time zone offset from Greenwich Mean Time (GMT),
Valid flight number (or tail number) and carrier (for airport or FBO pickups)

The required outputs in a valid Reservation Change Request Response Message include the following:
Confirmation number,
Segment number(s),
Supplier Code,
Requested service type,
Number of passengers,
Number of bags,
Vehicle type,
Corporate account number,
Lead passenger identification number,
Intermediary identification number,
Price quote for each vehicle type,
Price quote for each unbundled ancillary service (e.g., greeter service, stops, and other ancillary services),
Price quote disclaimer details,
Date of service,
Pickup time with time zone offset from GMT,
Requested drop off time,
Estimated drive time and miles,
Pickup location,
Drop off location (except for hourly service),
Change and Cancellation rules,
Other terms and conditions,
Error Message(s).

### 2.4.2 Processing Steps for Reservation Change Request Transaction Algorithm

The following steps must be completed as part of the Reservation Change Request Transaction Algorithm. The breakdown of the processing steps and their sequencing is not meant to imply a serial approach to the work flow of the algorithm. Some of these steps could potentially be performed simultaneously.

### Step 1: Check for Minimum Lead Time to Accept a Reservation Change Request

Each supplier must decide what type of service they choose to offer in a given Service Geography, to include on demand service (no lead time required to book) and pre-planned service (variable lead time required to book). If the requested pickup time is immediate and the supplier does not deliver on demand service, or if the pickup time does not support the lead time specified for pre-planned service, then a Reservation Change Request Response Message will be returned indicating there is no availability.

### Step 2: Calculate the Estimated Drive Time and Block Availability

Adding or Removing Passenger(s) from Shared Ride Service

If the Reservation Change Request Message seeks to add or remove a passenger to an existing shared ride reservation, then the Reservation Application initiates a search using the Confirmation Number in the payload of the Reservation Request Message. If a matching reservation is not found, then for add transactions an attempt is made to book a reservation with a new shared ride vehicle. If a shared ride vehicle is not available, then the Reservation Change Request Response Message will indicate that there is no availability.

If a matching reservation is found, the Inventory Management Application will check the passenger count and baggage count for the reservation in the Calendar Component to determine availability, revise the passenger and baggage counts if availability is present, and return a Reservation Change Request Response Message. If either the passenger or baggage counts in the Calendar Component do not support the requested number of additional passengers and baggage, then a Reservation Change Request Response Message will be returned with a reservation denial. Even if the pickup location coordinates do not match the existing reservation but the pickup time and location for the second reservation will not materially add to drive time (based on a pre-defined threshold), assuming the passenger and baggage counts are not exceeded, then the Availability Response Message will indicate availability.

If the appropriate shared ride reservation is found to remove a passenger, the Inventory Management Application will adjust the passenger count for the reservation in the Inventory Management Application Calendar Component to determine availability, and add appropriate content to the Reservation Change Request Response Message.

### Geography Exception Flag Present

For transfer service, if there is a Geography Exception Flag associated with the pickup and drop off addresses, call the GIS System Network Analysis API and receive back the Cartesian Coordinates, the Estimated Drive Time, and the Estimated Driving Distance, and the Estimated Drive Time and Driving Distances from the center point to the pickup point and from the center point to the drop off point. If the road geometry is not present in the GIS System, or if the GIS is offline, convert Cartesian to Spherical Coordinates as needed and use the Proprietary Algorithms. If the Proprietary Algorithms are used, consider Drive Time Increase Factors and other relevant run time parameters from the Rate Management Table Component.

### Missing Coordinates

If the Geography Exception Flag is not present, but neither Spherical nor Cartesian Coordinates for the pickup and drop off addresses are present in the inbound Reservation Change Request Message, call the GIS System address verification, geocoding, and network analysis services via APIs and receive back the Cartesian Coordinates, the Estimated Driving Distances, and the Estimated Drive Times between the pickup and drop off locations, from the center point to the pickup point, and from the drop off point to the center point. If the road geometry is not present in the GIS System, or if the GIS is offline, convert Cartesian to Spherical Coordinates as needed and use the Proprietary Algorithms. If the Proprietary Algorithms are used, drive times should then be adjusted using the Drive Time Increase Factors and other relevant run time parameters available in the Rate Management Table Component.

### Component Drive Time Calculations

If either the Cartesian or Spherical Coordinates are present in the Inbound Availability Request Message, using the Cartesian Coordinates, call the GIS network analysis function to calculate the Estimated Drive Times and Estimated Driving Distances between the pickup and drop off locations, from the center point to the pickup point and from the drop off point to the center point. If the road geometry is not present in the GIS System, or if the GIS is offline, convert Cartesian to Spherical Coordinates as needed and use the Proprietary Algorithms. If the Proprietary Algorithms are used, drive times should then be adjusted using the Drive Time Increase Factors and other relevant run time parameters available in the Rate Management Table Component.

### Total Drive Time Calculation and Availability Check

Use the component drive time calculations to calculate the Estimated Total Drive Time.

Total Drive Time=((Center Point to Pickup Point Drive Time+Pickup to Drop Off Point Drive

Time+Drop Off to Center Point Drive Time)*Drive Time Increase Factor)+

Stops Time+Minimum Lead Time Prior To Pickup Time

Check the requested supplier's availability for the requested vehicle type and ancillary service(s) by accessing the Inventory Management System Application Calendar Component. If relevant availability is open (i.e., the total drive time is available on the calendar and the requested ancillary services also are available), then calculate the price quote.

### Step 2: Calculate Price Quote

### Single Passenger Transfer Service

For transfer service, use the corporate account number if present, the passenger id number if present, intermediary id number if present, and ancillary services code(s) if present, to retrieve relevant run time parameters from the Rate Management Table Component, the Service Geography Additional Charges Table Component, the Tax Table Component, and the CRM Application, and then perform the following pricing calculations:

Total Price=Base Price+Driver Gratuity+Cost of Empty Return Leg+Additional Charges+

Local Sales Tax+Carbon Offset Cost+Cost of Ancillary Services+Stops Cost

Base Price=(Drive Time*Base Unit Cost*(100−Percent Discount))

Driver Gratuity=Base Price*Driver Gratuity Percentage

Cost of Return Leg=(Cost of Empty Return Leg*(100−Return Leg Percentage

Probability))

Submit relevant run time parameters to the Pricing Engine Component and generate a preliminary price quote by supplier. Compare the passenger's historical buyer behaviors with the newly generated price quote. If needed, adjust offers and price quotes per business rules.

### Shared Ride Transfer Service

Retrieve relevant run time parameters from the Rate Management Table Component, the Service Geography Additional Charges Table Component, the Tax Table Component, and the CRM Application, and then perform the following pricing calculations:

Total Price=Base Price+((Driver Gratuity+Cost of Empty Return Leg+Additional Charges+

Local Sales Tax+Carbon Offset Cost)/Passenger Capacity)

Base Price=(Drive Time*Base Unit Cost)+(Shared Ride Passenger Rate)

Driver Gratuity=Base Price*Driver Gratuity Percentage

Cost of Return Leg=(Cost of Empty Return Leg*(100−Return Leg Percentage

Probability))

### Hourly Service

For hourly service, use the corporate account number if present, the passenger id number if present, the intermediary id number if present, and the ancillary services code if present, to retrieve relevant run time parameters from the Rate Management Table Component, the Service Geography Additional Charges Table Component, the Tax Table Component, and the CRM Application, and then perform the following price calculations:

Total Price=Base Price+Driver Gratuity+Cost of Empty Return Leg+Additional Charges+

Local Sales Tax+Cost of Carbon Offset+Stops Cost+Cost of Ancillary Services

Base Price=(No. of Hours*Hourly Cost*(100−Percent Discount))

Driver Gratuity=Base Price*Driver Gratuity Percentage

Cost of Return Leg=(Cost of Empty Return Leg*(100−Return Leg Percentage

Probability

### Step 3: Return Availability for Originally Requested Vehicle Type and Ancillary Service(s)

This step will be processed only if availability for the new vehicle type and ancillary services is confirmed in Step 2. If availability for the new vehicle type and ancillary services is not confirmed, then this step will not be processed and the work flow will advance to Step 4. This approach ensures that the customer does not lose the availability of the previously reserved vehicle type and ancillary services before alternative inventory is available and accepted through a subsequent Reservation Change Request. This step also will occur if the customer chooses to cancel the reservation and select a different supplier.

Upon receiving a Reservation Change Request, the Inventory Management Application must first determine the vehicle type and base unit of inventory as well as the ancillary services that are no longer being requested and return availability to this inventory by accessing and updating the Inventory Management Application Calendar Component. This action will immediately restore this inventory for sale in other reservations.

### Step 4: Generate Reservation Change Request Response Message

Using the information collected in Steps 1 through 3, create a Reservation Change Request response message that presents a confirmation of the requested availability and pricing for the requested vehicle type and ancillary service(s) (e.g., greeter fee) and includes appropriate disclaimer text and terms and conditions. If there is no availability either for the requested vehicle type or ancillary service(s), create a Reservation Change Request response message communicating denial of the change request and the lack of availability for the applicable vehicle type and/or ancillary service(s).

### 2.5 Reservation Cancellation Request Transaction Algorithm

The Reservation Application processes a Reservation Cancellation Request Transaction as a result of receiving an inbound Reservation Cancellation Request Message from a channel partner or a contact center agent (i.e., an agent in a call center or a dispatch office).

Business rules and terms and conditions can apply to processing a reservation cancellation request. For example, most chauffeured transportation suppliers require a lead time in advance of the pickup time to accept a reservation cancellation. This lead time is required to prevent assignment and dispatch of a chauffeur to a pickup location only to have the reservation cancelled in a way that could result in a service defect or pricing dispute. These business rules will be stored as run time parameters in the Rate Management Table Component and retrieved as part of processing the reservation cancellation request.

Before the Reservation Application can confirm a cancellation to a reservation, the reservation cancellation request must be submitted to the Inventory Management Application to accomplish the following actions:
Return inventory availability for the cancelled vehicle type and ancillary services.
Create a Reservation Cancellation Request Response Message that either confirms or denies the cancellation.
   The following sections identify the required preconditions, inputs, outputs, and discrete process steps that must be implemented for the Reservation Cancellation Request Transaction Algorithm.

### 2.5.1 Required Pre-conditions, Inputs, and Outputs for Reservation Cancellation Request Transaction Algorithm

The required pre-condition for this transaction is submission of a valid inbound Reservation Cancellation Request message by the applicable channel partner or contact center agent to the Reservation Application.

The required inputs in a valid inbound Reservation Cancellation Request message include the following:
Confirmation number,
Segment number(s),
Supplier code,
Service type (i.e., airport transfer, point-to-point transfer, hourly service, group transfer, group charter, etc.),
Vehicle type,
Ancillary service(s) id(s),
Account identification number (if corporate discounts and preferences apply),
Lead passenger identification number (if lead passenger opts in to receiving personalized availability options, pricing, and other offers),
Travel intermediary number (if availability request is submitted by an intermediary and if pricing rules require up front disclosure of commissionable versus non-commissionable rates),
Valid pickup date and time with time zone offset from Greenwich Mean Time (GMT),
   The required outputs in a valid Reservation Cancellation Request response message include the following:
Cancellation number,
Segment number(s)
Supplier code,
Requested service type,
Vehicle type,
Corporate account number,
Lead passenger identification number,
Intermediary identification number,
Cancellation denial explanation text,
Date of service,
Pickup time with time zone offset from GMT,
Pickup location,
Cancellation rules,
Other terms and conditions,
Error Message(s).

### 2.5.2 Processing Steps for Reservation Cancellation Request Transaction Algorithm

The following steps must be completed as part of the Reservation Cancellation Request Transaction Algorithm. The breakdown of the processing steps and their sequencing is not meant to imply a serial approach to the work flow of the algorithm. Some of these steps could potentially be performed simultaneously.

### Step 1: Check for Minimum Lead Time to Cancel a Reservation Request

Each supplier must decide the lead time required to cancel a reservation in a given Service Geography, for both on demand service (no lead time required to book) and pre-planned service (variable lead time required to book). If the requested pickup time is immediate and the supplier does not allow cancellations for on demand service, or if the pickup time does not support the lead time specified for cancelling pre-planned service, then a Cancellation Request Response Message will be returned denying the request.

### Step 2: Return Availability for Vehicle Type and Ancillary Service(s)

Removing Passenger(s) from Shared Ride Service

If the Cancellation Request Message seeks to remove one or more passengers and/or ancillary services from an existing shared ride reservation, then the Reservation Application will initiate a search using the Confirmation Number. If a matching reservation is not found, then the Cancellation Request Response Message will be returned denying the cancellation. If a matching reservation is found, the Inventory Management Application will adjust the passenger count for the reservation in the Calendar Component and add appropriate content to the Cancellation Request Response Message. This action will immediately restore this inventory for sale in other reservations.

### Cancellation of a Single Passenger Reservation

Upon receiving a Reservation Cancellation Request, the Inventory Management Application must first determine the vehicle type and base unit of inventory as well as the ancillary services that are no longer being requested and return availability to this inventory by accessing and updating the Calendar Component. The Reservation Application also generates and persists a Cancellation Number and appropriate content for the Cancellation Request Response Message.

### Step 3: Generate Reservation Cancellation Request Response Message

Using the information collected in Steps 1 and 2, create a Reservation Cancellation Request response message that presents a confirmation of the cancellation of the requested vehicle type and ancillary service(s) (e.g., greeter). If the cancellation request cannot be processed for the vehicle type and/or ancillary service(s), create a Reservation Cancellation Request response message communicating denial of the cancellation request and the reasons for the denial.

### 2.6 Automated Job Closeout and Reconciliation Process Algorithm

This process and related algorithm will replace a manual process that has caused a lot of customer dissatisfaction and has encouraged fraudulent increases in the trip price on the part of chauffeurs, dispatchers, and passengers. Many corporate customers of chauffeured transportation companies insist that third party systems audit the Automating job closeout and reconciliation will significantly decrease the opportunity for these problems.

At time of reservation, the least cost route and all lat/long coordinates related to pricing are persisted as part of the trip. These coordinates would include locations and road segments associated with incidental costs and local taxes. Throughout the service, the vehicle location will be tracked and displayed on the GPS console in the supplier's dispatch office based on transmission of GPS coordinates every “x” seconds by a device in the vehicle. As the service is delivered, the vehicle's “bread crumb trail” of GPS coordinates will be collected and persisted as part of the trip.

At the end of the service (possibly using a scheduled overnight batch procedure to protect online system service levels) a comparison of the GPS coordinates of the least cost route and the actual route will be performed along with a comparison of the respective price quotes. If certain incidental costs or local taxes present in the Reservations price quote are not justified in the actual route taken, or if different incidental costs and local taxes have to be added as a result of the actual route taken, an additional credit card transaction will take place to process a credit or debit as part of job closeout.

Note that the inputs and outputs of this transaction are assumed to be at the single reservation segment level of detail to allow transmittal of a final zero balance statement to the appropriate passenger and arranger.

### 2.6.1 Required Pre-conditions, Inputs, and Outputs for Job Closeout and Pricing Reconciliation Transaction Algorithm

The required pre-condition for this transaction is persistence of the least cost route and related GPS Coordinates computed at time of reservation and persistence of the actual route taken and the related GPS Coordinates collected at the time of service delivery.

The required inputs in a valid Job Closeout and Reconciliation Request process include the following:

Confirmation number,
Segment number,
Base Unit Cost Applicable To Drive Time,
Least Cost Route and related GPS Coordinates and Road Segments computed at time of reservation,
All-Inclusive Price Quote at time of reservation,
Actual Route and related GPS Coordinates and Road Segments collected at time of service delivery,
Actual Price Quote at the end of service delivery,
Passenger Cell Phone Number or Email Address,
Arranger Cell Phone Number or Email Address.
   The required outputs in a valid Job Closeout and Reconciliation Request process include the following:
Confirmation number,
Segment number,
All-Inclusive Price Quote at time of reservation,
Actual Price Quote at the end of the service delivery,
Passenger Cell Phone Number or Email Address,
Arranger Cell Phone Number or Email Address,
Zero Balance statement.

### 2.6.2 Processing Steps for Job Closeout and Reconciliation Transaction Algorithm

The following steps must be completed as part of the Job Closeout and Reconciliation Transaction Algorithm. The breakdown of the processing steps and their sequencing is not meant to imply a serial approach to the work flow of the algorithm. Some of these steps could potentially be performed simultaneously.

### Step 1: Compute Least Cost Route at Time of Reservation

At time of Availability and Reservation processing, the Inventory Management Application will call the GIS Network Analysis function to compute the least cost route between the pickup and drop off locations. The Network Analysis Function computes the least cost route by considering a network of possible routes between the two locations and factoring in the driving distance, the day of week, the start time, and the historical traffic speed on that day of week and start time in the relevant geography. From this information, the Network Analysis function selects the least cost route, or the route with the shortest drive time. This route and the related GPS Coordinates and Road Segment Identifiers are then persisted at time of Reservation Confirmation.

### Step 2:Compute All-Inclusive Price Quote

The Pricing Engine Component uses the estimated Drive Time, the Base Unit Cost Applicable to Drive Time and, depending on the nature of the service, potentially other run time parameters from the Rate Management Table Component to compute the base price of the least cost route. The Pricing Engine then uses the Road Segments associated with the least cost route to compute the incidental costs and the local taxes and adds these costs to the base price to arrive at an all-inclusive price quote for the trip.

### Step 3: Collect GPS Coordinates and Road Segments for Actual Route at Time of Service Delivery

Throughout the actual service delivery, the GPS transmitter in each vehicle transmits the GPS Coordinates every “x” seconds and persists these coordinates on a central data base for each supplier. The GPS Coordinates are used to display the vehicle location in near real-time on a GPS Tracking Console in the Suppliers' Dispatch Offices as well as to identify which Road Segments the vehicle is using on the actual route.

Step 4: Compare Least Cost Route to Actual Route

A Reconciliation Function compares the Least Cost Route with the Actual Route and identifies any variances in use of Road Segments. These variances are used to add or subtract incidental costs and local taxes and compute a new all-inclusive price versus what was quoted at time of Reservation. If there are no variances in use of the Road Segments, then the Pricing Engine will issue a final statement for the trip reflecting the all-inclusive price quote at time of Reservation.

### Step 5:Complete Pricing Adjustments

If the Reconciliation Function computes an all-inclusive price quote for the actual route that differs from the price quote at time of reservation, the Pricing Engine processes a credit card adjustment and issues a final zero balance statement explaining the difference between the all-inclusive price quote at time of reservation and the final all-inclusive pricing applicable to the actual route.

### Step 6: Transmit Zero Balance Statement to Customers and Suppliers

The zero balance statement generated in Step 5 is transmitted to the Lead Passenger, Arranger, and Supplier for each reservation segment. Run time parameters stored in the profiles of the CRM Application determine the method used to transmit the statement to each recipient (i.e., email, text message, or fax).

### 2.7 Reservation Retrieval Request Transaction Algorithm

This transaction enables retrieval of an existing reservation for purposes of reading, modifying, or cancelling the reservation. The following sections identify the required preconditions, inputs, outputs, and discrete process steps that must be implemented for the Reservation Retrieval Request Transaction Algorithm.

### 2.7.1 Required Pre-conditions, Inputs, and Outputs for Reservation Retrieval Transaction Algorithm

The required pre-condition for this transaction is the successful booking and persistence of the reservation intended for retrieval and submission of a valid inbound Reservation Retrieval Request Message by the applicable channel partner or contact center agent to the Reservation Application.

The required inputs in a valid inbound Reservation Retrieval Request message include the following:
Confirmation number,
Segment number(s),
Supplier code,
Service type (i.e., airport transfer, point-to-point transfer, hourly service, group transfer, group charter, etc.),
Vehicle type,
Ancillary service(s) id(s).
   The required outputs in a valid outbound Reservation Retrieval Response message include the following:
Confirmation number,
Segment number(s),
Supplier code(s),
Requested service type,
Number of passengers,
Number of bags,
Relevant vehicle type code(s),
Corporate account number,
Lead passenger identification number,
Intermediary identification number,
Price quote for each vehicle type,
Price quote for each unbundled ancillary service (e.g., greeter service, stops, and other services),
Price quote disclaimer details,
Date of service,
Pickup time with time zone offset from GMT,
Requested drop off time,
Estimated drive time and distance,
Pickup location,
Drop off location (except for hourly service),
Change and Cancellation rules,
Other terms and conditions,
Error Message(s).

### 2.7.2 Processing Steps for Reservation Retrieval Request Transaction Algorithm

The following steps must be completed as part of the Reservation Retrieval Request Transaction Algorithm.

### Step 1—Process Inbound Reservation Retrieval Request Message

The Reservation Application reads the payload of the inbound message and attempts to retrieve the applicable reservation. If the reservation is not found, the Reservation Application will issue the appropriate error message(s). If the reservation is found, the content of the reservation is retrieved.

### Step 2—Generate Reservation Retrieval Response Message

Following a successful or unsuccessful attempt to retrieve a reservation, the Reservation Application will assemble a Reservation Retrieval Response Message, including any relevant error messages, and transmit that message to the originally requesting system.

### 2.8 Push Transaction Request Algorithm

The Reservation Application processes a Push Transaction Request Message as a result of confirming a new, changed, or cancelled reservation. The purpose of the Push Transaction is to replicate a transaction and its related information successfully processed in the TDIAM System to the local supplier fulfillment system.

There is only one outbound Push Transaction Message and one inbound Push Transaction Message. Together, they accommodate six total transactions. Both the outbound and inbound messages have a set of codes designating what type of transaction—a reservation add, change, or cancel transaction—and message type—Request or Response Message—needs to be processed by the receiving system.

Note that the inputs and outputs of this transaction are assumed to be at the single reservation segment level of detail, which is the design most frequently supported by local supplier systems.

The following sections identify the required preconditions, inputs, outputs, and discrete process steps that must be implemented for the Push Transaction Request Transaction Algorithm.

### 2.8.1 Required Pre-conditions, Inputs, and Outputs for Reservation Retrieval Transaction Algorithm

The required pre-condition for this transaction is a reservation add, change, or cancellation transaction successfully processed in the TDIAM System.

The required payload content in a valid outbound Push Transaction Request message includes the following:
Confirmation number,
Segment number,
Supplier code,
Transaction Type,
Requested service type,
Number of passengers,
Number of bags,
Relevant vehicle type code(s),
Corporate account number,
Lead passenger identification number,
Intermediary identification number,
Price quote for each vehicle type,
Price quote for each unbundled ancillary service (e.g., greeter service, stops, and other services),
Price quote disclaimer details,
Date of service,
Pickup time with time zone offset from GMT,
Requested drop off time,
Estimated drive time and distance,
Pickup location,
Drop off location (except for hourly service),
Change and Cancellation rules,
Other terms and conditions.

The required payload content from the local supplier system in a valid inbound Reservation Retrieval Response message include the following:
TDIAM Confirmation number,
Segment number,
Local System Confirmation number,
Local System Segment number,
Supplier code,
Transaction Type,
Error Message(s).

### 2.8.2 Processing Steps for Push Transaction Request Algorithm

The following steps must be completed as part of the Push Transaction Request Algorithm:

### Step 1—Successful TDIAM Add, Change, or Cancel Transaction

This transaction is event driven and triggered by the successful processing of a predecessor Reservation Add, Change, or Cancel transaction in the central TDIAM System.

### Step 2—Generate Push Transaction Request Message

Following successful completion of Step 1, the Reservation Application generates the request message with the appropriate transaction and message type codes to indicate whether the message pertains to an Add, Change, or Cancel transaction request.

### Step 3—Process Push Transaction Request Message

The Reservation Application in the local supplier system processes the Push Transaction Request Message and either generates a confirmation of successful processing or issues one or more error messages.

### Step 4—Generate Push Transaction Response Message

Following a successful or unsuccessful attempt to process a Push Transaction Request Message, the Reservation Application will assemble a Push Transaction Response Message, including any relevant error messages, and transmit that message to the TDIAM System.

### Step 5—TDIAM Confirmation and Exception Processing

The TDIAM System will either persist the confirmation information from the local supplier system or, if the payload content of the Push Transaction Response Message contains any error messages, issue an immediate alert to appropriate TDIAM and local supplier technical support and customer service staff.

### 2.9 Supplier Waybill Request Transaction Algorithm

The Reservation Application processes a Supplier Waybill Request Message as a result of confirming a new, changed, or cancelled reservation. This transaction is time dependent and driven off of run time parameters stored in the supplier partition of the CRM Application.

The purpose of the Supplier Waybill Request Message is to meet public utility commission (PUC) driven regulatory requirements regarding the information all chauffeurs must have in their possession during the service delivery in case a PUC inspector requests it. The Waybill information must therefore be transmitted not only to the local supplier system but, depending on the timing requirements, directly to the chauffeur who may already be getting staged to deliver the relevant service.

There is only one outbound Supplier Waybill Request Transaction Message and one inbound Supplier Waybill Response Transaction Message. Together, they accommodate six total transactions. Both the outbound and inbound messages have a set of codes designating what type of transaction—a reservation add, change, or cancel transaction—and message type—Request or Response Message—needs to be processed by the receiving system.

Note that the inputs and outputs of this transaction are assumed to be at the single reservation segment level of detail, which is the design most frequently supported by local supplier systems.

The following sections identify the required preconditions, inputs, outputs, and discrete process steps that must be implemented for the Supplier Waybill Request Transaction Algorithm.

### 2.9.1 Required Pre-conditions, Inputs, and Outputs for Reservation Retrieval Transaction Algorithm

The required pre-condition for this transaction is a reservation add, change, or cancellation transaction successfully processed in the TDIAM System.

The required payload content in a valid outbound Push Transaction Request message includes the following:
Supplier TCP Number,
Supplier Name,
Supplier Service Type Name,
Supplier Telephone Number,
TDIAM Confirmation Number,
Segment Number,
Local Supplier System Reservation Number,
Local Supplier System Segment Number,
Transaction Type,
Intermediary Identification Number,
Intermediary First and Last Name,
Intermediary Business Address,
Intermediary ARC/IATA Number,
Intermediary Cell Phone Number,
Booking Date and Time,
Booking Channel Name,
Booking Sub-channel Name,
Vehicle Identification Number,
Vehicle License Plate Number,
Chauffeur Name,
Chauffeur Cell Phone Number,
Greeter Name,
Greeter Cell Phone Number,
Pickup Date and Time,
Pickup Address,
Price quote for each vehicle type,
Lead Passenger First and Last Name,
Lead Passenger Cell Phone Number.

The required payload content from the local supplier system in a valid inbound Waybill Response message includes the following:
TDIAM Confirmation Number,
Segment number,
Supplier Code,
Transaction Type,
Local System Confirmation number,
Local System Segment number,
Supplier TCP Number,
Supplier Name,
Supplier Service Type Name,
Supplier Telephone Number,
Transaction Type,
Lead Passenger First and Last Name,
Error Message(s).

### 2.9.2 Processing Steps for Waybill Request Transaction Algorithm

The following steps must be completed as part of the Waybill Transaction Request Algorithm:

### Step 1—Successful TDIAM Add, Change, or Cancel Transaction

This transaction is event and time driven and triggered by the successful processing of a predecessor Reservation Add, Change, or Cancel transaction in the central TDIAM System as well as timing parameters stored in the supplier partition of the CRM System.

### Step 2—Generate Waybill Request Transaction Message

Following successful completion of Step 1, the Reservation Application generates the request message with the appropriate transaction and message type codes to indicate whether the message pertains to an Add, Change, or Cancel transaction request. This message may be routed to the supplier's local system, to a print application in the supplier's local dispatch office, to an eFax application, and/or directly to the relevant chauffeur's and greeter's smart phone app. Routing instructions for this message will be stored in the supplier partition of the CRM Application.

### Step 3—Process Waybill Request Transaction Message

The Reservation Application in the supplier's local system, the printer application, the eFax application, or the chauffeur's and greeter's smart phone app processes the Waybill Request Transaction Message and either generates a confirmation of successful processing or issues one or more error messages.

### Step 4—Generate Waybill Response Transaction Message

Following a successful or unsuccessful attempt to process a Waybill Request Transaction Message, the Reservation Application and/or the smart phone app will assemble a Waybill Response Transaction Message, including any relevant error messages, and transmit that message to the TDIAM System.

### Step 5—TDIAM Confirmation and Exception Processing

The TDIAM System will either persist the confirmation information from the local supplier system or, if the payload content of the Waybill Response Transaction Message contains any error messages, issue an immediate alert to appropriate TDIAM and local supplier technical support and customer service staff.

### 2.10 Automated Availability Search, Booking, and Dispatch of Partner Vehicles

By defining a service provider's affiliate network and farm out partners in the Service Provider Directory, it becomes possible to automate the availability search, booking, and dispatch of partner inventory managed by the TDIAM Inventory Management Application. There are at least two business scenarios where this capability is useful:

### 1. Service Exceptions

Exception situations such as severe traffic congestion, mechanical failures, and accidents that can result in late pickups can require reassignment of the trip to another available vehicle. Use of geo-fencing will automatically determine the exception situations and trigger an alert to the Dispatch Office of the original service provider originally assigned the trip.

If the service provider does not have an available vehicle, the Inventory Management Application can then search for available partner inventory in the same geography and automatically reassign the trip to the an available vehicle nearest to the pickup location. The Inventory Management Application will then trigger transmission of a Waybill Request Message to the new service provider and driver.

If affiliate or farm out partner inventory is not available, the Inventory Management Application can automatically reassign the trip to a new service provider who has an available vehicle that can meet the trip requirements and is closest to the pickup point.

### 2. No Availability

As part of an availability search, if a service provider lacks available inventory in their own service geography or for a trip occurring in another geography where they may or may not have distribution, the service provider can opt to have an available partner vehicle be included as part of their response message. The Directory of Service Providers must have the affiliate network and farm out partners identified for a given service provider who opts into this function. The Inventory Management Application must also have physical and available inventory for an affiliate or farm out partner at the time of availability processing. Additional business rules governing the use of this capability will be developed as part of the application design.

### 3 Extensibility of Availability Processing and Booking Algorithms to Other Modes of Private and Public Sector Surface Transportation

This document illustrates how TDIAM in the transportation domain uses well understood principles of Geometry and a GIS to simplify searching, shopping, and booking transactions for chauffeured transportation (see Section 1.3.5.1 for a more detailed explanation of how the principles of Cartesian and Minkowski Geometry are used by GIS Systems and by proprietary algorithms for shared ride service and for service geographies lacking the presence of the road geometry in a GIS). There are many other for hire public and private sector transportation and hospitality services that could benefit from this approach by offering a simple and consistent method of searching for inventory availability.

Since many modes of surface transportation have a TDIAM problem and require the same basic parameters to search, shop, and book the related inventory, it is possible to design a general purpose meta-search algorithm for this business domain. A general purpose algorithm for searching and booking multi-modal surface transportation, baggage and package delivery, as well as hospitality venues like restaurants, hotels, spas, and other forms of lodging, generally requires the same basic parameters. These parameters define the movement through space and time required to fulfill the requirements of the consumer(s)'s itinerary.

Six basic consumer, location, and time related parameters can be used to search and schedule availability not only for chauffeured transportation but also for all other public and private modes of surface transportation, as well as various modes of hospitality.
(1) Number in Party—The number of passengers or guests related to a specific itinerary.
(2) Number of Bags—The number of bags within three sizes of baggage accompanying the passengers or guests on their itinerary.
(3) Service Start Location—Expressed as spherical coordinates or as an address that is already converted into spherical or Cartesian coordinates in the prevailing Geographic Information Systems (GIS).
(4) Service Start Time—Expressed in terms of a start date (i.e., month, day, and year) and the hour and minute of the day the consumer(s)'s itinerary is scheduled to start.
(5) Service End Location—Expressed as spherical coordinates or as an address that is already converted into spherical or Cartesian coordinates in the prevailing Geographic Information Systems (GIS).
(6) Service End Time—Expressed in terms of an end date (i.e., month, day, and year) and the hour and minute of the day the consumer(s)'s itinerary is scheduled to end.

Using these six variables, a consumer can perform an availability search and request a reservation for virtually any form of travel, transportation, and hospitality. For itineraries that do not move through space but only time (e.g., restaurant reservation, hotel reservation, etc.), the two location coordinates will, of course, be identical.

Looking a little further into the future, these same common coordinates and meta search algorithms can be applied to simplify distribution (and navigation) of private, for hire transportation like autonomous, self-drive vehicles (e.g., the Google Car), shared mobility solutions like Zip Car, iGO, FlyteCar, Lyft, and for public sector for hire transportation like subway, surface passenger rail, ferry, and bus services.

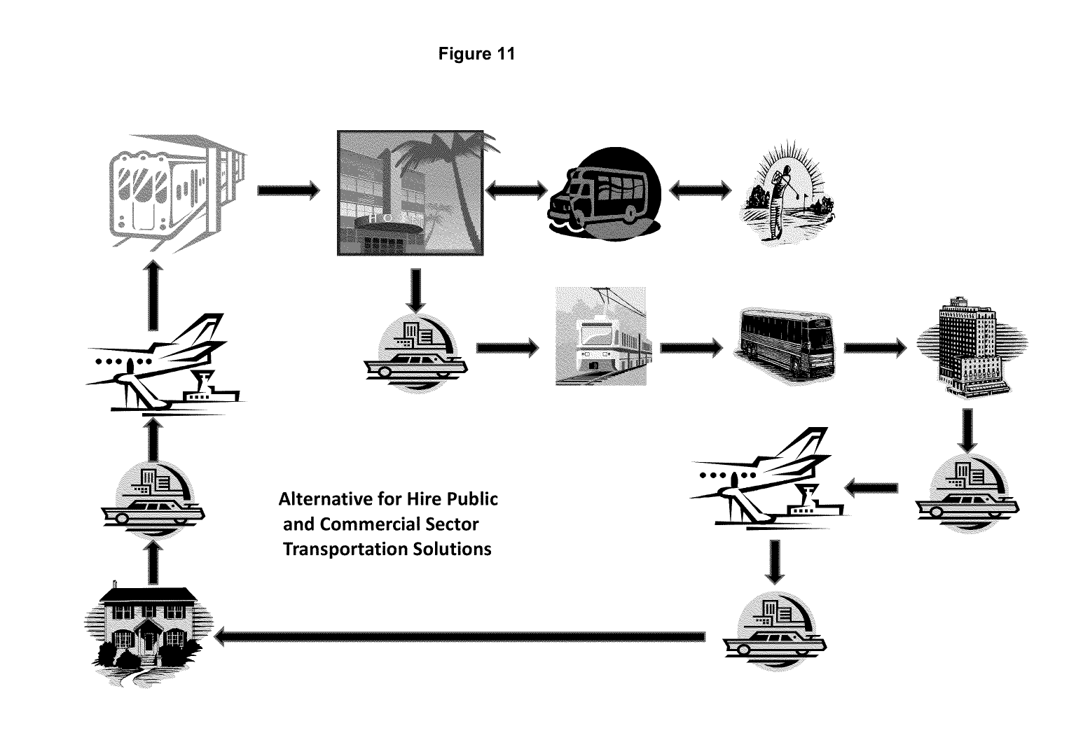

As search parameters, the Start and End Locations can be converted to geo-location coordinates and then used to search any electronic surface transportation schedules, and any reservations and inventory management systems, that accommodate geo-location and time coordinates as a means of searching for availability and for distributing their respective transportation services. The availability response message would return the actual location and time coordinates available to satisfy the search, or a set of coordinates as close as possible to the coordinates in the original availability request message. The consumer can then make the decision to adjust his time and location coordinates or to eliminate a mode of transportation unsuitable to their itinerary. FIG. 11, illustrates a typical itinerary involving multi-modal surface transportation.

The absence of a common meta search solution that can empower consumers by identifying all of the available public and private sector transportation and hospitality solutions suitable for a given intermodal travel itinerary constitutes one of the major consumer pain points in travel planning and distribution. Because the search and availability methods for these travel solutions are frequently handled quite differently and there are no centralized distribution options for many of these services, consumers are often not even aware of all of their options. To do so, they are often forced to conduct a confusing array of availability searches and booking procedures on both local and global channels to satisfy the needs of their itinerary with their preferred modes of transportation and hospitality. The user experience on these various channels typically differs widely and customer dissatisfaction with this experience often leads to lack of trial or outright avoidance of some transportation services.

This lack of consistency and parity in distribution methods can actually shape demand for these services in a suboptimal manner by masking the full spectrum of service options, including more efficient and environmentally responsible options, available to the consumer. In turn, this complexity will result in the incomplete and suboptimal use of all modes of transportation needed to solve future congestion problems and an incomplete picture of consumer preferences. In the absence of accurate and complete consumer preference information, federal and local government transportation planners risk developing the wrong policy and the wrong transportation solutions. This outcome could have catastrophic effects on already congested metropolitan areas throughout the world.

A TDIAM System that considers which of the six parameters apply to each mode of transportation and hospitality and that offers an intuitive, consumer friendly interface could result in an effective solution for meta-search, shopping, and booking an intermodal travel itinerary consisting of mixed use of private and public sector surface transportation and hospitality. A true Integrated Proactive Travel Assistant (IPITA) would be available for both business and leisure travelers.

Taking this IPITA concept one step further, new technologies like natural language processing and semantic search could significantly improve the consumer interfaces by reducing the number of keystrokes required to launch a meta-search, return a more complete availability shopping screen, and actually book a reservation. Use of natural language processing would enable the consumer to submit their search request using speech instead of text and use of semantic search would enable search through both structured and unstructured data to return a more accurate and complete availability display. Both technologies will have dramatic impacts on human to computer interactions and future graphical user interfaces, and especially for travelers who need to create or modify their itineraries on mobile devices with smaller form factors.

A simple example, and the typical use case frequently overlooked by surface transportation suppliers, is the business person traveling from Chicago to New York City and attending meetings in both Manhattan and Staten Island. If a central, multimodal distribution system presented all of the travel options between these two boroughs in advance, the travel consumer could choose use of for hire private car service, taxi, and for hire public sector options like bus service, subway service, or the Staten Island Ferry, depending on the location and time coordinates of that part of their itinerary. Because each mode of surface transportation has its own proprietary approach to searching, shopping, and booking transportation services, however, and because most public sector transportation service can only be booked on local channels, consumers are forced to struggle in the middle of their travel itinerary to understand their transportation options.

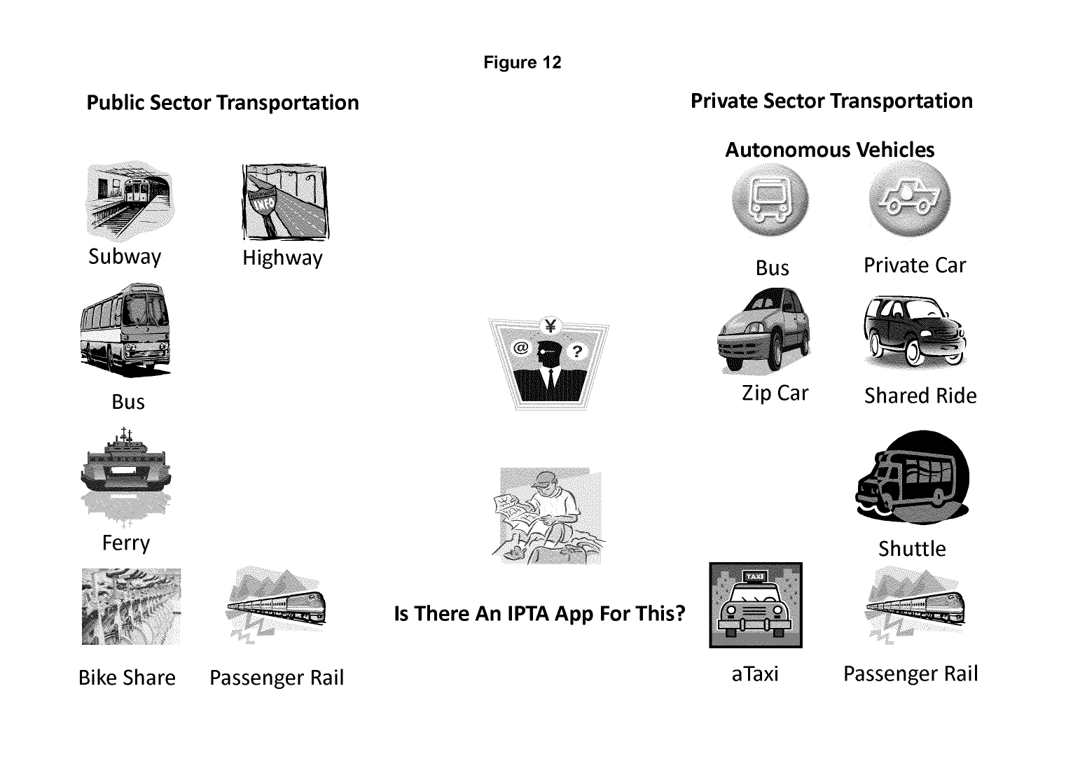

In FIG. 12 there is shown the plight of the business and leisure traveler in trying to understand their surface transportation options. The time has come to introduce a common set of meta-search algorithms and an IPITA to solve this problem, such as the one explained in Section 1.1. Coupling this type of meta-search algorithm with semantic search capabilities (i.e., the ability to “improve search accuracy by understanding searcher intent and the contextual meaning of terms as they appear in the searchable data space”) would further improve the consumer experience and present a more complete set of travel options. Stronger collaboration between Federal, State, and local jurisdictions, leading private sector transportation and hospitality companies, and higher education and non-profit research organizations is needed to facilitate building this IPITA.

### 4 Marketing Automation Applications

The chauffeured transportation has traditionally not invested in marketing automation applications commonly adopted by many of the other travel verticals. There are many reasons for this lack of investment—undercapitalization, the fragmentation of the industry, the lack of familiarity of the operators with these applications and how they can help manage the demand side of the business, the perceived need for these applications on the part of the operator and, most importantly, the absence of a centralized, global distribution and inventory management system needed to capitalize on the opportunities afforded by these applications. Much the same can be said for most public sector forms of surface transportation—public sector governmental entities do not generally run their respective transportation businesses using private sector best practices.

Once the TDIAM System solves the basic inventory management problem, however, there is an added opportunity for both private and public sector operators to increase their revenue and profitability through marketing automation applications. These applications include the following:
Customer Segmentation—Analysis of customer behaviors, grouping of those behaviors into Market Segments, understanding how those behaviors can contribute to shareholder value, and the creation of products and services that appeal to those behaviors.
Rational Pricing Programs—Using the business intelligence gathered from customer segmentation, create pricing offers targeted toward specific segments and use “fences” to prevent other segments from obtaining related pricing discounts. These pricing programs use controls in the Pricing Engine to stimulate incremental demand, prevent inventory spoilage in low demand periods, and maintain focus and control in making offers available only to the targeted segments.
Revenue Management—Use operations research models and predictive analytics to ensure that only the most profitable segments and customers gain access to a limited, perishable inventory. Typically the operations research models run overnight on a daily basis and set the inventory management strategy each day for the next “x” days. The models analyze historical demand and the current booking pace leading up to the subject forecast period and present an inventory management strategy using both coarse and fine grained inventory and pricing controls available in the TDIAM System.
Dynamic Pricing—Use operations research models and predictive analytics in real time to compute dynamically throughout the day a “bid price,” or the lowest price required to access available inventory after each reservation add, change, and cancel transaction.
Multi-Channel Marketing System—This application enables rapid development of marketing offers and campaigns, distribution of those offers across all available channels, the ability to track the effectiveness and profitability of the offers throughout the campaign, and the ability to make mid-course corrections to the underlying marketing strategy of a campaign.

These applications can make a significant impact in today's chauffeured transportation industry in helping operators realize increased revenues, profitability, and growth and manage the demand and revenue side of the business. These applications also can assist with some of the more difficult logistical problems of managing a mobile fleet.

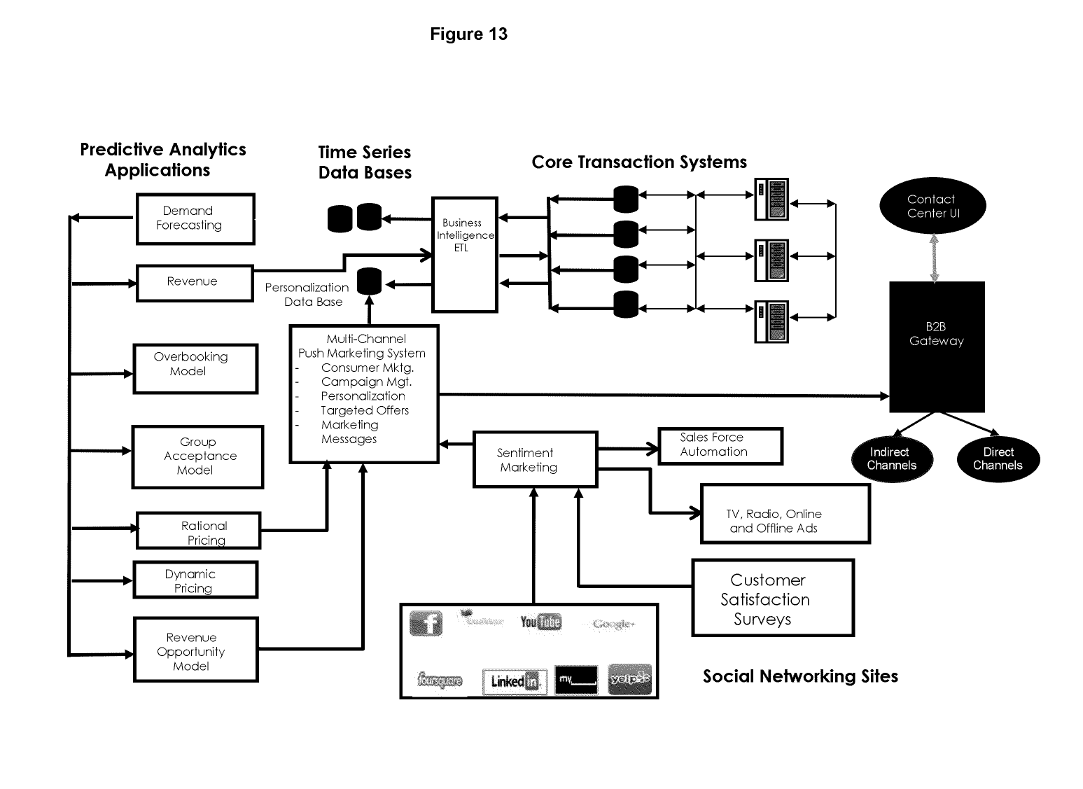

Even the larger chauffeured transportation companies, and the Private Equity Groups who typically own them, have neither focused nor invested in these applications. Their focus has been to manage down unnecessary operational costs, a step that needed to be taken. But there must be a balance struck between managing the cost and revenue sides of the business. And for all of the reasons already discussed, these applications will become that much more important as we transition into the era of autonomous vehicles and shared mobility solutions. FIG. 13 presents an overview of the Revenue Management and Marketing Automation Applications.

The following sections present further explanation of how these applications can help automate marketing and logistics decisions and strategies and have a dramatic impact on revenue and profitability.

### 4.1 Customer Segmentation Application

Customer segmentation focuses on analyzing customer behaviors, grouping those behaviors into Market Segments, understanding how those behaviors can contribute to shareholder value, and creating products and services that appeal to those behaviors. Typical behaviors that can distinguish one segment from another include the propensity to plan a trip versus to require complete flexibility in travel plans up to and including the date of service, price sensitivity and elasticity, and booking behaviors. Suppliers can develop products and services that appeal to these behaviors and thereby generate incremental demand and increased market share.

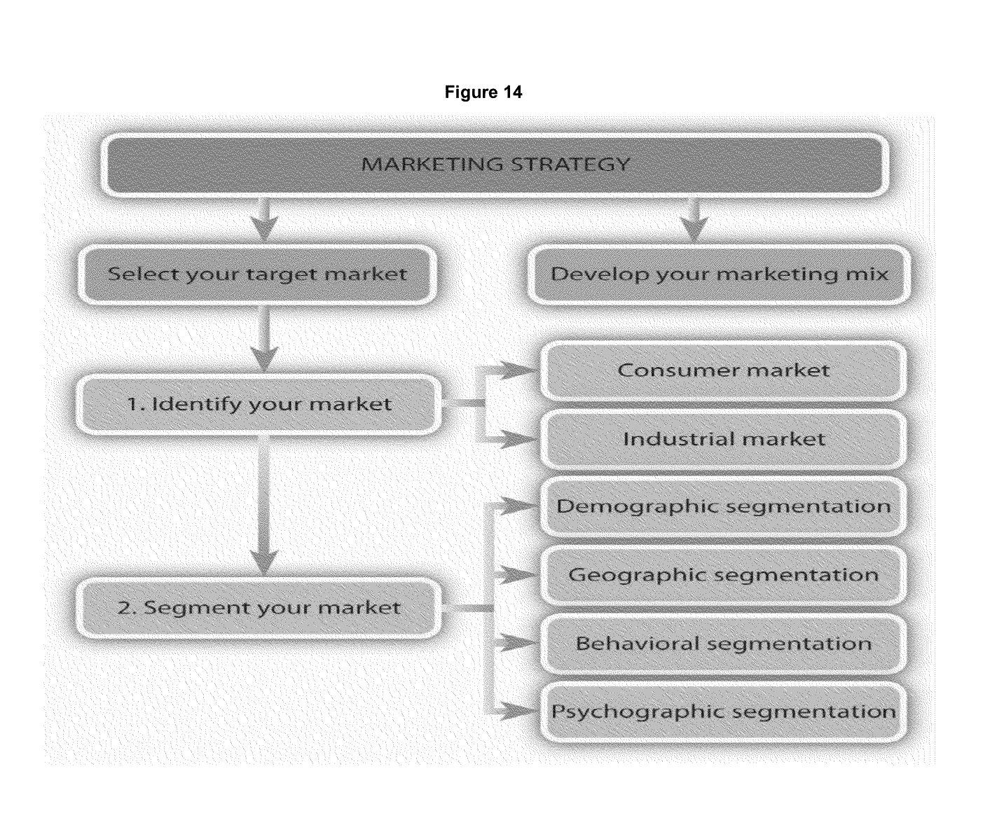

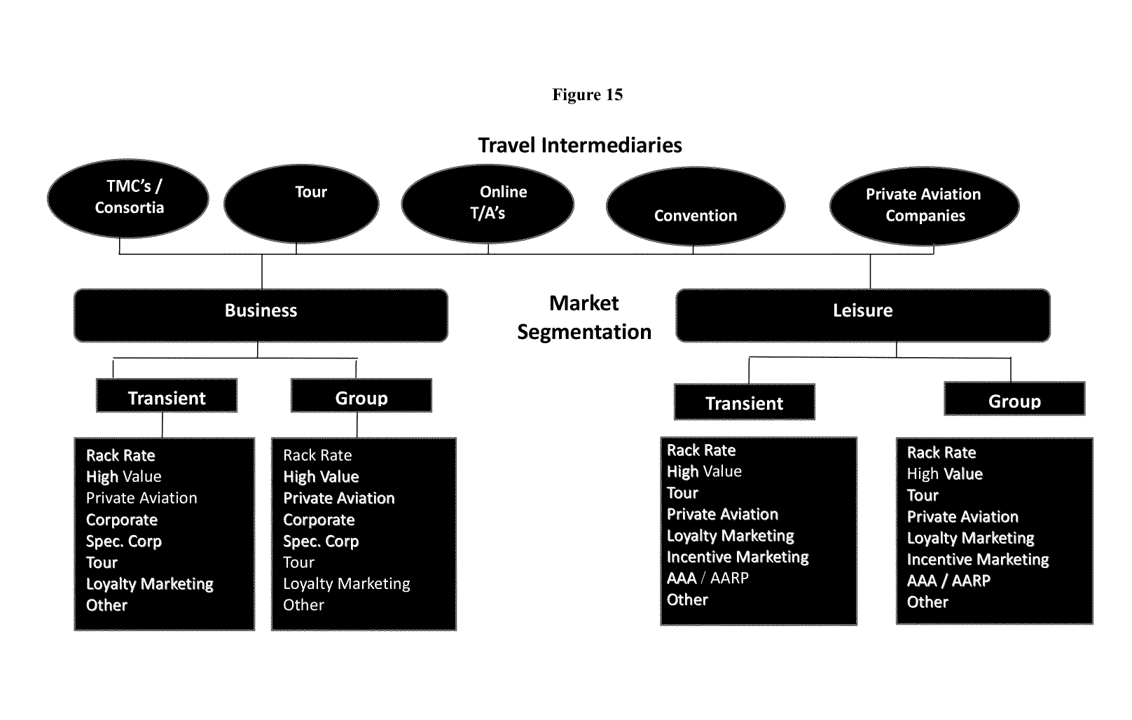

Travel industry market segmentation schemes typically reflect two major segments—Business and Leisure—and two sub-segments—Transient (i.e., reservations involving less than “x” customers) and Group (i.e., reservations involving more than “x” customers). FIG. 14 presents a typical travel industry marketing strategy. Segmentation is accomplished in several ways taking into account demographic, geographic, psychographic, and behavioral distinctions between segments. FIG. 15, presents a typical travel industry customer segmentation scheme, with the four major segments broken down further into sub-segments or micro markets. Note that intermediaries are clearly distinguished from customer segments, implying that separate marketing programs are required to address these constituents who can influence the travel buy decision.

The chauffeured transportation industry has typically focused on only two customer segments—the corporate transient and corporate group segments—and their products and services are largely tailored to these segments. Although these segments can drive an appreciable volume of trips, they also tend to be price sensitive, which can lead to razor thin margins. There are several reasons for this price sensitivity. The more expensive forms of chauffeured transportation like limousine service are considered a discretionary service for all but the most important executives, and especially during a recession. The other factor is competition for the same customers. Since these two segments and their larger customers are pursued by every chauffeured transportation company, the customers almost never sole source their business and almost always require responses to RFP's before making a buy decision. A major factor in the buy decision, especially if the decision maker is a procurement manager, is inevitably price. The widespread absence of rational pricing and revenue management programs in the chauffeured transportation industry leave operators with little choice but to compete on price—in effect, their uninformed competitors and customers are their greatest enemies to achieving and sustaining profitability.

With inventory utilization rates for the smaller chauffeured transportation operators as low as forty percent as a result of the recession, a more comprehensive customer segmentation strategy is needed to stimulate demand in other segments and sustain profitability. The analysis required to segment customers is typically done by applications separate from the Reservations and Inventory Management Applications and running on separate computer capacity. A business intelligence platform is used to accomplish the analysis using both reservation activity and history information containing segmentation information in each transaction. Frequency analyses are run for each segment to discover distinguishing behaviors that can then be used to develop products and services that are appealing to discrete segments and can stimulate incremental demand.

Customer segmentation is an important prerequisite to other marketing automation applications and a critical need for the chauffeured transportation industry. Looking forward to the introduction of autonomous vehicles and shared mobility solutions, this analysis will be equally important. Solving the safety, mobility, environmental, and congestion problems will be dependent on understanding consumer behavior and offering efficient transportation solutions that also appeal to those behaviors.

### 4.2 Rational Pricing Application

Rational Pricing addresses the set of business rules that define how pricing discounts are granted to targeted customer segments. These rules are considered “rational” because the discounts result from a give and take between customers and suppliers. The discount is granted in return for consumer behaviors that drive shareholder value. The discounts are typically offered during low demand periods and intended to stimulate demand in the targeted segment(s). This incremental demand prevents “spoilage” of a perishable inventory.

To prevent segments not targeted for the discounts from gaining access to them, “fences” are created for rational pricing programs that typically tie back to segment behaviors.

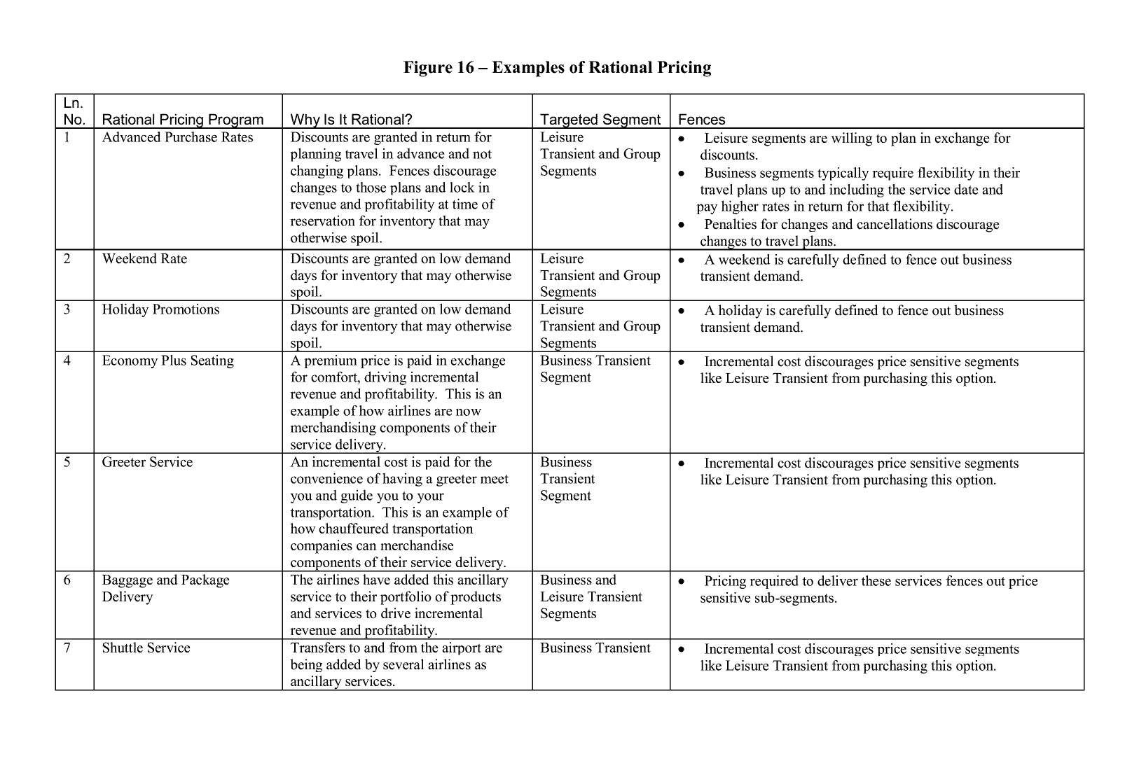

In FIG. 16 there is shown examples of rational pricing and explains why they are rational. For each example, it also explains the concept of “fences,” which are pricing controls that prevent segments not being targeted from getting access to the pricing discounts.

Other forms of rational pricing are emerging as a result of the challenges faced by the airline industry in sustaining profitability. Even after all of the mergers and acquisitions, bankruptcies, and restructuring, most of the major airlines operated at a 1% margin in 2012. This problem originated in part as a result of past distribution strategies that resulted in airlines competing strictly on price and schedule, with no other way to distinguish their service offerings. To return to profitability and renew their relevance to consumers, the airlines are following two new strategies that are essentially forms of rational pricing. The model for both of these strategies is Amazon.com, which has taken online marketing and personalization to new levels of sophistication. The following sections address these strategies and explain their relevance to surface transportation.

### 4.2.1 Merchandising

To increase revenues and profitability, airlines are unbundling many of the traditional components of their service delivery and charging an incremental cost for these services in addition to the base fare. The consumer gets to decide if these services are worth their cost. Examples of merchandising include the following:
Baggage fees,
Priority boarding,
Purchase of meals and beverages on the plane,
Select seating.

Some airlines take an opposite tack and market the re-bundling of these services into their core service delivery with no incremental fee—for example, “On Southwest, bags fly free.”

Surface transportation companies have their own opportunities to practice merchandising. Examples include the following:
Incremental fees for greeter service,
Incremental fees for event coordinators,
Incremental fees for baby seats,
Incremental fees for management reporting,
Incremental fees for ADA compliant vehicles.

### 4.3 Revenue Management Application

In the absence of even a coarse grained inventory management system, there has been little opportunity for the chauffeured transportation industry to practice the art and science of revenue management. Revenue management requires a combination of mature business processes and mature business applications to realize its related business benefits. In addition, it requires a culture of continuous improvement with the ability to learn and change. A sizable investment in business process reengineering coupled with capital investments in new and sophisticated business applications also are required to realize business benefits. These fundamental requirements have yet to be met by the industry.

That being said, once the inventory management application is in use, there is an opportunity to introduce the concepts, business processes, and systems infrastructure of revenue management over time and at a reasonable cost. The following sections outline the steps the surface transportation industry should take to realize the benefits all other travel verticals have enjoyed for over 20 years.

### 4.3.1 Base Unit of Inventory and Revenue Management Key Performance Metric

One of the first steps in initiating a revenue management program is to define the unit of inventory and the revenue management metric that will be used as the key indicator of performance over time. It is useful to look at how some of the other travel verticals chose their units of inventory and defined the key revenue management performance metric.

| Travel | Base Unit | Revenue Management |
|---|---|---|
| Vertical | of Inventory | Key Performance Metric |
| Airline | Airline Seat | Revenue per available seat mile |
| Hotels | Hotel Room Night | Revenue per available room night |
| Rental Car | Vehicle Day | Revenue per available vehicle day |

Currently, the unit of inventory in the chauffeured transportation industry is the vehicle and assigned driver for a variable period of time. With the advent of autonomous vehicles, the driver will no longer be part of the unit of inventory. To take into account required and discretionary chauffeur and vehicle downtime, the logical revenue management key performance metric is revenue per available vehicle hour, where the number of vehicle hours can be appreciably less than 24 on any given day.

### 4.3.2 Coarse Grained Versus Fine Grained Inventory Controls

The coarse grained controls planned for the base Inventory Management Application is open or closed for availability by individual vehicle and chauffeur for a variable period of time. There are many other fine grained inventory controls that could be included in this application and help maximize revenue and profitability by providing more opportunities to manage available inventory. The recommended steps needed to define those controls are as follows:

Understand all non-temporal aspects of the inventory asset and how they might affect availability and pricing:
Number in party,
Number of bags,
Specialty skills,
Vehicle types,
Additional stops,
Venues,
Distance travelled,
Service Geography,
Customer segment,
Individual customer value.

Define the applicable temporal components and whether or not they affect the availability or pricing of the non-temporal components:
Shortest duration of service (e.g., an hour),
Incremental service durations (e.g., an hour),
Time of day, day of week, weekday versus weekend,
Seasonal factors, holidays, events, special occasions,
Time booked prior to service date,
Service start and end patterns,
Time needed to stage inventory,
Immediate, on demand access to inventory,
Promotion period.

This analysis leads to the following types of fine grained inventory controls:
Open/Closed by Location or Operating Unit,
Open/Closed by Vehicle Type or Skill (e.g., greeter or event coordinator),
Open/Closed by Geographic Area (e.g., a geo-fenced area),
Open/Closed for Pre-defined Service Duration (e.g., trip must be minimum of 1 hour and maximum of 8 hours for service duration),
Open/Closed for Service Start and End Dates and Times,
Open/Closed by Time of Day, Day of Week, Weekday Versus Weekend, or Pre-defined Season,
Open/Closed Based on Pre-defined Promotion Period,
Open/Closed Based on Days Booked Prior to Service Date (or Other Fences),
Open/Closed for Immediate On Demand Access,
Open/Closed for Trips Requiring More Than “x” Minutes of Staging Time.

It is also possible to “nest” these controls to create even more fine grained restrictions. As an example:
Open/Closed for Vehicle Type and Pre-defined Service Duration,
Open/Closed for Immediate On Demand Access to Vehicle Type,
Open/Closed by Vehicle Type for Trips Requiring More Than “x” Minutes of Staging Time.

In addition, these restrictions can be paired with market segment codes or customer value categories to further restrict access to inventory based on current demand and the profitability of a segment or customer value category.

In practice, the availability of these controls without a computer assist in applying them can lead to situations where sales are blocked inadvertently and inappropriately, creating inventory management “Red Flags.” Edits are needed to apply business rules during setup of these controls that will prevent Red Flags. But the real breakthrough in the use of these controls will occur as a result of adding predictive analytics models to the Revenue Management Program that automatically determine the optimal inventory management strategy—i.e., the set of controls that will result in only the most valuable customers accessing the limited supply of an operator's perishable vehicle and chauffeur inventory.

### 4.3.3 Use of Predictive Analytics Technologies

Revenue Management Programs have long relied on sophisticated mathematical models to predict the future and harvest the related business benefits. Predictive Analytics enjoys a heritage dating as far back as the United States Space Program, when operations research models were used to optimize the fuel flow through the Saturn V rocket and calculate the reentry trajectory for the Apollo 8 Space Capsule as it traversed the dark side of the moon without a precise understanding of the moon's gravitational field.

Within the travel industry, predictive analytics technologies were first used by American and Delta Airlines to launch their revenue management programs. Consulting firms spun off from the airlines then adopted these technologies to other travel verticals, including hotels, car rental, and cruise lines.

Predictive analytics models perform a variety of calculations to optimize demand against supply. They include the following:
Demand Forecasting Model—Using a minimum of two years of reservation activity and history and the booking pace leading up to the forecast period, this model presents a constrained and unconstrained forecast of demand by customer segment or value category, vehicle type, length of rental, and rental patterns. The unconstrained forecast predicts total demand regardless of available inventory. The forecast is typically run overnight on a daily basis and predicts demand as far out as 365 days into the future. Most revenue management systems allow update of the forecast by operations staff throughout the day based on local knowledge not considered in the models.
Optimization Model—Using the demand forecast as input, this model creates the inventory Management strategy that will result in the most profitable customers gaining access to a supplier's perishable inventory. Using the coarse and fine grained controls available in the the inventory management application, the optimization model generates the fine grained inventory management controls required to produce optimal revenue and profitability results for the forecast period. Although this model is typically run overnight, most revenue management systems support re-optimization during the day following a change in the forecast.
Overbooking Model—Using historical cancellation rates, the overbooking model predicts the number of cancellations leading up to the date and time of service, and provides an overbooking recommendation to operations management that will prevent inventory spoilage. Operations management typically has the authority to override this recommendation based on local knowledge (e.g., changes in weather or other local demand sensitive conditions not considered in the model).
Group Acceptance Model—The demand forecast predicts how much transient demand will throughout the forecast period. This demand must be evaluated against group demand competing for the same inventory. The role of the Group Acceptance Model is to perform this evaluation and determine the breakeven rate needed to accept a group and thereby displace typically higher rated transient business.
Revenue Opportunity Model—This model serves as a Monday morning quarterback, comparing the potential revenue opportunity with the actual revenue achieved. Loss of revenue is tied back to specific decisions made by operations that either positively or negatively affect revenue and profitability. Evaluation of this data drives continuous improvement in revenue management business processes and related decisions.

There are a number of software packages that offer these types of predictive analytics models for other vertical industries. The most cost effective approach to introducing this technology to the chauffeured transportation industry is to partner with a firm that offers these packages and customize them for the industry. The short list of potential partners in this space includes JDA, Pros, and Oracle's Demantra System.

### 4.3.4 Dynamic Pricing Application

Dynamic pricing is typically used to supplement the predictive analytics models by further optimizing revenue management strategy in real time throughout the day. Following each reservation add, change, and cancel, a “Bid Price” is recalculated based on recent demand trends. The Bid Price is the minimum price required to gain access to all remaining available inventory. Several dynamic pricing software packages are available from potential partners, to include JDA, Pros, QCue, and Mercent. Some customization of these packages will likely have to be done to tailor their algorithms to the chauffeured transportation industry.

### 4.4 Multi-Channel Marketing Application

In low demand periods, targeted promotions and marketing campaigns can help stimulate demand and increase revenues and profitability. Multi-channel marketing systems support the development of promotions and campaigns, distribute the offers across all targeted segments and channels, and measure the effectiveness of the campaigns and promotions. These applications also allow mid-course corrections to the marketing strategies driving these initiatives.

There are several multi-channel marketing software packages already available. Terradata's Aprimo, IBM's Unica, SAS Institute, ExactTarget, and SAP top the list of potential partners in this space. SalesForce.com and Oracle's Bee Hive software package also offer these capabilities. These applications typically are integrated with personalization applications to make sure that the offers are as relevant as possible to the targeted consumers.

### 5 Operations Automation Applications

Both prior to and after the advent of autonomous vehicles, there are opportunities to automate operations functions that can increase revenue and profitability, simplify dispatch and tracking, and enable automated job closeout.

### 5.1 Inventory Staging Application

A key difference between surface transportation inventory and other inventory in the travel industry is that the inventory is mobile throughout the day and frequently must be repositioned or staged in the service geography to achieve an efficient response to demand. Trips can take a vehicle out into a remote suburb or a part of a metropolitan area with low demand. If a return leg is not available, the driver and the dispatch office must make a decision regarding where to stage the vehicle for the next trip.

Demand patterns within a given service geography can shift in predictable ways throughout the day. In the morning, many trips originate in the airports and suburbs and travel into the downtown metropolitan areas. Just the opposite pattern occurs in the late afternoon. Stochastic events (e.g., changes in weather, traffic accidents, citywide conventions, parades, etc.) that can occur throughout the day also can affect these demand patterns in unpredictable ways, creating more complexity and urgency in staging the inventory.

Optimal fleet management involves staging the right inventory in the right location at the right time. This is especially important when delivering on demand service, as in a taxi business model. With a small fleet in a small metropolitan area, this problem is manageable without computer assistance. As the fleet grows and the metropolitan area expands in area, traffic density, and logistics complexity, computer assistance in solving this problem can make a material impact on fleet management, which can in turn affect both operating costs and revenues.

The models used to predict future demand patterns for the purpose of maximizing revenues and profitability also can be used to predict where to stage inventory in response to those demand patterns. The focus changes from forecasting the number of customers by segment or value category and by length of rental to the number of trips originating and ending in specific geo-fenced areas by time of day. Vehicle type and rental length patterns by time of day also must be considered to stage the inventory correctly within each geo-fenced area. Even the best operations and dispatch managers will have challenges competing against a computer assisted fleet optimization model.

Two optimization models actually are required. The first model would run overnight, working off of two years of reservation history containing vehicle type, rental length, time of day, and location information, including geocodes for each pickup and drop off location. This model would set the strategy for the start of the day and stage the inventory throughout the day based on predicted demand patterns. A second optimization model would focus on changes to the predicted demand patterns throughout the day and re-optimize fleet management as required.

With the advent of autonomous vehicles, these optimization models will become that much more important because the driver's knowledge of demand patterns will no longer be available to help guide fleet management decisions. This application, therefore, also will facilitate the transition to autonomous vehicles and shared mobility solutions.

### 5.2 GPS Tracking of Affiliate Trips

The fragmentation present in the chauffeured transportation industry results in the vast majority of service providers having presence in only one market and managing less than 17 vehicles. To increase their availability within and outside their service geography, most service providers establish farm out partners and an affiliate network in other service geographies.

When service providers delegate trips to their farm out and affiliate partners, they often do so on behalf of key customers and retain responsibility for the quality of the service delivery. To do so, they usually track the service fulfillment by calling the partner's dispatch office or driver to monitor on time performance, which is the greatest customer satisfaction driver. This process is manual, labor intensive, error prone, and often ineffective in monitoring performance.

To remedy this situation and introduce a Minimum Value Product that can be built quickly, offer an early opportunity to generate revenue for investors, and also provide key building blocks for the longer term TDIAM Reservations and Inventory Management Applications, a TDIAM GPS Tracking Application will be built that initially focuses on tracking of affiliate inventory assigned to deliver a service provider trip. The first building block is the Service Provider Directory, which can be marketed to convention bureaus and other target customers who need information on service providers in their markets but have no interest in taking reservations or managing inventory. Each service provider will define their affiliate network and farm out partners within this directory.

The second building block is the GPS Tracking Application, which will include an internet based GPS Tracking Console as well as a mobile application that a farm out or affiliate driver will use to activate GPS tracking of his vehicle when performing a service provider's delegated trip. The GPS Tracking Console will make use of geo-fences consisting of concentric circles drawn around the pickup point designating increments of “x” minutes of drive time to the pickup location. When the vehicle crosses the boundary line of each concentric circle, the GPS Tracking application will automatically calculate the number of minutes left to the pickup time and compare that calculation to the estimated number of minutes of drive time calculated by the GIS that is still needed to reach the pickup location. If the number of minutes left prior to the pickup time is “x” minutes less than the minutes of remaining drive time, the GPS Tracking application will issue an alert to the service provider and to the partner's dispatch office notifying both parties of an exception situation.

The third building block is an open source chat software product, which will enable real-time problem solving between the partner driver, partner dispatch office, passenger, and service provider. The use of these three building blocks integrated as part of a focused application should significantly improve and streamline the traditional process.

### 5.3 In-Vehicle Guidance Systems

A key issue when autonomous vehicles dominate the market is how to guide the vehicles since the drivers are no longer present to choose the route and operate the vehicle. There are various types of systems that are anticipated to control the vehicle but the technology is far from perfected:
Traffic sensors situated every x yards on streets and highways will guide the vehicles while on individual roadways.
Centralized traffic management systems will keep track of traffic problems and accidents within a specific geography and route vehicles appropriately around congestion. These systems will fall under the jurisdiction of the state and local governments and will communicate with vehicle guidance systems to override their originally planned routes.
Vehicle-to-Vehicle (V2V) communications will prevent accidents and streamline traffic flow by “platooning” autonomous vehicles, thereby safely shrinking the distance between the vehicles and achieving an optimal speed.

Finally, in the case of private and public sector for hire transportation, the route to the pickup point needed to guide the autonomous vehicle still has to be sent to the vehicle from the NWS or similar system and acted upon by a vehicle guidance system.

Changes to that route driven by traffic congestion or other factors also have to be understood by the central distribution system. An in-vehicle application must therefore be built to guide the vehicle to the pickup point using location aware services and this application must communicate any changes to the route back to the central distribution system. This in-vehicle guidance system must be built by the point in time when autonomous vehicles reach critical mass, which could be in as little as ten years and as much as twenty years.

### 6 Monetizing the TDIAM System and Marketing Automation Applications

The TDIAM System will involve time and expense to build and to operate. Judicious use of the right hardware, middleware, and packaged software applications can make a significant impact on time to market and development cost. Licensing strategies must be applied to the use of these software packages that will result in highly scalable but also cost-effective solutions.

The potential return on this investment is, however, also significant. The TDIAM can accommodate all forms of private and public sector surface transportation, which represents a multi-billion dollar market. The TDIAM offers many ways to reduce supplier operating costs but also presents several ways to monetize the related products and services.

The following sections present methods for monetizing the distribution and inventory management applications and the marketing automation applications. They are not intended to present a full business case and plan but rather simply illustrate the various methods for monetizing these new assets.

### 6.1 Net Reservation and Message Fees

Centralized, global reservations and inventory management systems have traditionally monetized their services by charging monthly net reservations fees (i.e., in a given month, the number of new reservations minus cancellations). Recent trends in travel distribution, however, have led most global channels to charge by the message in addition to net reservations. The primary reason for this change ties back to the growing number of messages required to book a reservation. This so called “look to book” ratio has steadily increased as a result of distribution channels handling multi-media, rich content and the sheer amount of information and options now available to consumers as a result of meta search algorithms and aggregator channels.

Net reservation and message fees must be value based and priced to be affordable by the transportation operator. Fees for taxi net reservations and messages should be lower than higher margin limousine service and higher than lower margin shared ride service. The other key factor in setting fee levels is transaction volumes. Since these volumes could change dramatically over time, allowance should be made to adjust these fees over time.

### 6.2 Software Rental Fees

The only practical way to deploy the TDIAM System and Marketing Automation Applications is to use a Multi-Tenant, Software as a Service (SaaS) model. Most chauffeured transportation operators do not have the capital to invest in a premise based software license model but can afford monthly rental fees as long as inventory utilization rates increase and warrant the expenditures. Use of the SaaS model will reduce friction in attracting and retaining a base of viable suppliers.

To facilitate this approach, the reservations and inventory management systems should be developed as an integrated suite of applications that still enable operators to choose which applications they wish to rent.

### 6.3 Advertising and Marketing Fees

The marketing automation applications afford an opportunity to run marketing campaigns and promotions. Most operators do not have the requisite skills, experience, and time to plan out their marketing strategies let alone run campaigns. Operators who prefer to outsource their marketing strategy, campaigns, and personalization initiatives to trained marketing professionals should have the option to do so. In addition, use of the marketing automation applications to do multi-channel push marketing should result in message fees that recover costs and earn a modest margin based on the number of offers sent out across various channels.

### 6.4 Training Fees

Operators will need training in virtually every TDIAM System and marketing automation application. Training should be value priced and offer varying levels of difficulty and expertise required to master the curriculum. Smaller operators may opt not to invest in some applications because the return is not there.

### 6.5 Consulting Fees

Operators may need periodic consulting support especially during transitions to new applications to help them with mastering new business processes, set up and initialization of new applications, and adoption of new pricing, inventory management, and revenue management disciplines. Consulting fees should be value based depending on the expected return the operator will realize from this investment.

### 6.6 Demand Data

Companies like Google are interested in demand data by location and are willing to pay a considerable amount of money to gain the insights this data offers. Recent statements by Google indicate that part of the reason they invested $238 M in Uber is the contractual agreement that Uber will share all demand data for teir on demand service with Google.

The TDIAM System will collect and maintain demand data for both on demand and pre-planned trips making the data that much more valuable than Uber's.

The content of all references cited in the instant specification and all cited references in each of those references are incorporated in their entirety by reference herein as if those references were fully denoted in the text.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

What is claimed is:

1. A fully-automated time dependent inventory asset management system, comprising:
Interface means enabling a consumer to request time dependent use of an asset;
Cost estimating means to estimate the expected total cost of the time dependent use of the asset, said estimating means comprising:
Route computation means to compute possible best routes for said asset, said computation means taking into account pertinent factors that can affect the total travel time for said asset, wherein said factors include: type of road, road network geometry, minkowski geometry, historical traffic patterns, expected road construction, and expected weather;
Route selection means to select a best route based on the route computation means;
Route costing means to compute the total cost for time dependent use of the asset over the selected best route, wherein the total cost includes anticipated incidental costs;
Route storing means to save the selected best route in memory;
Electronic Calendar means to check the availability of suitable assets matching the requested asset, and if a suitable asset is available, to book a selected suitable asset for the consumer (or otherwise to inform the consumer that no suitable asset is available),
Charging means to place a charge against a consumer's financial account in accordance with the estimate of the expected total cost at the time said suitable asset is booked;
Automated dispatching means to dispatch said suitable asset robotically on the required date based on passenger entry of location and time coordinates, as well as vehicle type requirements at time of reservation, matching these requirements automatically to available assets, and blocking the availability of the matching asset on the vehicle calendar;
Job Closeout means to finalize all charges to said consumer upon termination of use of said asset; said job closeout means including a step of comparing the actual route travelled by said asset with the best route stored in the reservation data base or in memory, and providing a final adjustment to the estimated cost if said actual route varies significantly from said best route.

2. The system of claim 1, further including an automated, coarse grained, inventory management of an individual vehicle or fleet of vehicles using a calendar that can track variable rental periods and maintain accurate availability at the individual vehicle level of detail.

3. The system of claim 1, further including the ability of a service provider to farm out trips automatically when the service provider's own inventory is no longer available.

4. The system of claim 1, further including a service provider to define a network of remote affiliate partners in other markets who can contribute inventory to the TDIAM System.

5. The system of claim 1, further including an automated, alternative workforce and vehicle management options by service provider.

6. The system of claim 1, further including an automated dispatch of the vehicle by the passenger at time of reservation, thereby eliminating the need for manual dispatch just prior to the service delivery.

7. The system of claim 1, further including a simplified setup of zone pricing using a GIS to draw the zones, export of geocodes defining each zone and loading of these zone definitions into the pricing system

8. The system of claim 1, further including a refinement of single and intermodal itinerary searches using constraints such as least cost, number and type of modes of transportation, total trip duration, vehicle age, supplier safety rating, supplier customer service rating, and carbon footprint and offset cost.

9. The system of claim 1, further including an automated reassignment and dispatch of a trip to the nearest available affiliate or farm out partner vehicle whose inventory is managed by the STI Global System.

10. The system of claim 1, further including geo-fencing to trigger alerts to the service provider's dispatch office that a driver will be late to the pickup point.

11. The system of claim 1, further including the ability for a service provider to monitor remotely on a GPS console an affiliate delegated trip during the actual service delivery.

12. The system of claim 1, further including an automated reassignment of the trip to a new service provider based on search for the nearest available vehicle meeting the trip requirements or on a pre-defined prioritization scheme.

13. The system of claim 1, further including the automated ability to search for an available vehicle owned by a pre-defined affiliate or farm out partner in the same or different geography and dispatch the trip to the partner vehicle.

14. The system of claim 1, further including an application of four dimensional geometry to calculate drive time in geographies where the road network has not yet been mapped.

15. The system of claim 1, further including the use of a GIS System to calculate the least cost route using the GIS network analysis function.

16. The system of claim 1, further including the application of cost and margin factors to the total drive time to enable accurate pricing.

17. The system of claim 1, further including an association of incidental costs like tolls, airport fees, parking fees, local taxes, and carbon offset costs as part of the road geometry, or with a set of geocodes, to enable an all-inclusive price quote at time of reservation.

18. The system of claim 1, further including an all-inclusive price quote and the ability to perform credit card settlements at time of reservation.

19. The system of claim 1, further including an automated comparison and reconciliation of the costs quoted at time of reservation with the costs of the actual route taken and issuance to the consumer of a zero balance statement.

20. The system of claim 1, further including the use of a GIS to simplify zone pricing using geo-fences and the ability for the pricing engine to determine if a pickup and drop off location fall within a geo-fence corresponding to a pricing zone.
